(19) United States
(12) Patent Application Publication
(10) Pub. No.: US 2009/0313055 A1
(43) Pub. Date: Dec. 17, 2009

(54) COMPUTER-BASED SYSTEM AND METHOD FOR FACILITATING TRAVEL PLANNING FOR A PROSPECTIVE TRAVELER

(76) Inventors: Natalie Martin, San Diego, CA (US); John Hartman, San Diego, CA (US); Kingsley Nicholas Wientge, San Diego, CA (US); Dan Defenbaugh, La Mesa, CA (US); Bradly Feeley, La Mesa, CA (US)

Correspondence Address: SHEPPARD, MULLIN, RICHTER & HAMPTON LLP, 990 Marsh Road, Menlo Park, CA, 94025, US

(21) Appl. No.: 12/139,421

(22) Filed: Jun. 13, 2008

(51) Int. Cl. G06Q 50/00; G06Q 10/00

(52) U.S. Cl. 705/6; 705/5

(57) ABSTRACT

A travel, e.g., honeymoon, planning system comprises a travel planning tool operative to provide a first set of at least one first travel information request to a first user and to receive a first set of at least one first travel information response from the first user; a match tool coupled to the travel planning tool and operative to rate travel properties based upon the first set of at least one first travel information response of the first user; a booking tool coupled to the match tool and operative to enable the first user to book a specific travel property based on the travel property ratings; and an experience planing tool coupled to the booking tool and operative to track travel planning progress.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention pertains generally to computer-based systems and methods for recommending a travel experience to a prospective traveler, planning a travel itinerary, and booking items on the travel itinerary.

### BACKGROUND

Most travel booking websites require a prospective traveler to know where and when he or she wants to travel. The website requires the prospective traveler to input a destination city and range of travel dates in order to receive search results that include information pertaining to the pricing and availability of various travel accommodations.

But prospective travelers who use travel booking websites are often unsure of their actual travel dates when using such websites. Such prospective travelers also are often unsure of where they want to travel. Thus, a user of a travel booking website often needs to make up fictional travel dates and destination cities in order to learn pricing and availability. Pricing and availability are important variables in a prospective traveler's planning and decision-making prior to actually booking a trip. These variables vary depending upon date and location, among other things.

Additionally, search results provided by travel booking websites typically show all results for the specified destination city and travel dates, rendered with limited sorting and filtering (e.g., star rating, price, etc.). Users may find such search results to be overwhelming and unhelpful.

Because a prospective traveler's trip objective and desired travel experience might be unknown at the time of booking, a prospective traveler might not know whether the trip that he or she is booking will likely result in a sub-optimal travel experience. Present travel websites often permit a user to book a travel item at a sub-optimal time or to choose a sub-optimal travel location—for example, when pricing is high, availability is limited, crowds are large (peak season), animals are hard to view or hunt, or weather is sub-optimal.

Some travel booking websites additionally provide traveler reviews of the various hotels, attractions, cruises, etc. that can be booked through the websites. But prospective travelers using such websites often lack insight as to whether the users who wrote the traveler reviews share their travel values and trip objectives. Prospective travelers thus may have difficulty assessing whether such traveler reviews are relevant to them, and may additionally find the traveler reviews to be conflicting and unreliable.

There is a need for a system and method for recommending a travel experience to a prospective traveler that can overcome the problems involved in present travel booking websites.

### SUMMARY

In accordance with an embodiment, the present invention provides a travel planning system comprising a travel planning tool operative to provide a first set of at least one first travel information request to a first user and to receive a first set of at least one first travel information response from the first user; a match tool coupled to the travel planning tool and operative to rate travel properties based upon the first set of at least one first travel information response of the first user; a booking tool coupled to the match tool and operative to enable the first user to book a specific travel property and related travel items without limitation such as activities, flights, cars, and ground transportation based on the travel property ratings; and an experience planning tool coupled to the booking tool and operative to track travel planning progress.

Regarding the system, the travel planning system may be dedicated to honeymoon traveling. The travel planning tool may enable the first user to identify desired travel attributes including travel type and activity preferences. The travel planning tool may enable the first user to select required attributes and desired attributes. The travel planning tool may also enable a second user, or more users, to provide desired travel attributes, and the tool may merge the inputs to generate a single output. The resulting output may give greater weight to travel attributes that are selected by more than one prospective traveler. The required and preferred attributes may include, without limitation, hotel rating information, hotel amenity ratings, travel type, activities information, nightlife information, and food/restaurant information.

The match tool may rate and rank properties by examining required attributes and desired attributes. The match tool may exclude recommendations based on personality typology (profile), actual inputs, inferred preferences (based on expert knowledge about the property and location), and experience by other relevant users.

The experience planning tool may track travel and activity needs of the first user and booking of the travel and activity needs. The itinerary planning tool may make recommendations to achieve a good travel experience.

The travel planning tool may enable a second user or more users to view at least a portion of the first travel information responses. The travel planning tool may enable the first user to select which first travel information recommendations to share with a second user or more users. Users may select different methods of sharing the information, such as using a web form to send an e-mail, or copy and paste a URL for another user, printing the recommendations, or placing the recommendations into another user's account.

The travel planning tool may be operative to provide a second set of at least one second travel information request to the second user and to receive a second set of at least one second travel information response from the second user. The travel planning tool may be operative to provide and receive additional such sets. The travel planning tool may be operative to recommend an activity, product, or action to improve a travel experience or an activity experience. The match tool may be operative to rate and rank travel properties based upon the first set of at least one first travel information response and additional sets of at least one additional travel information response. The travel information response need not include a geographic location.

The travel planning system may further comprise an advertising and promotion tool operative to recommend items of possible interest based on the travel information responses, as well as demographic, psychographic, and travel personality or profile details. The advertising and promotion tool may be operative to provide a link to an external advertiser website. The advertising and promotion tool may also be operative to provide relevant articles and information that lack a link to an external advertiser website.

In accordance with another embodiment, the present invention provides a travel planning (e.g., matching) method comprising providing a first set of at least one first travel information request to a first user; receiving a first set of at least one first travel information response from the first user; rating and ranking travel properties based upon the first set of at least one first travel information response of the first user; enabling the first user to book a specific travel property and related travel items without limitation such as activities, flights, rental cars, and ground transportation based on the travel property ratings; and tracking travel planning progress.

Regarding the method, the method may be dedicated to honeymoon traveling. The method may further comprise enabling the first user to identity desired travel attributes including travel type and activity preferences. The method may further comprise enabling the first user to select required attributes and desired attributes. The required and preferred attributes may include without limitation hotel rating information, travel type, activities information, nightlife information, and food/restaurant information. The rating properties may include examining required attributes and desired attributes. The method may further comprise travel and activity needs of the first user and booking of the travel and activity needs. The method may further comprise making recommendations to achieve a good travel experience. The method may further comprise enabling a second user to view at least a portion of the first travel information responses. The method may further comprise enabling the first user to select which first travel information responses to show the second user. The method may further comprise providing a second set of at least one second travel information request to the second user and receiving a second set of at least one second travel information response from the second user. The method may further comprise recommending an activity, product or action to improve a travel experience or a product, item, or action to improve an activity experience. The method may further comprise rating and ranking travel properties based upon the first set of at least one first travel information response and the second set of at least one second travel information response. The first set of first travel information response need not include a geographic location. The method may further comprise advertising and promoting items of possible interest based on the travel information responses.

In accordance with another embodiment, the present invention provides a travel planning system comprising means for providing a first set of at least one first travel information request to a first user; means for receiving a first set of at least one first travel information response from the first user; means for rating travel properties based upon the first set of at least one first travel information response of the first user; means for enabling the first user to book a specific travel property based on the travel property ratings; and means for tracking travel planning progress.

### BRIEF DESCRIPTION OF THE DRAWINGS

FIG. 1 is a block diagram of a travel planning network system, in accordance with an embodiment of the present invention.

FIG. 2 is a block diagram of a travel planning server, in accordance with an embodiment of the present invention.

FIG. 3 is a block diagram of a travel planning system, in accordance with an embodiment of the present invention.

FIG. 4 is a block diagram of a back end database, in accordance with an embodiment of the present invention.

FIG. 5 is a block diagram of a travel property database structure, in accordance with an embodiment of the present invention.

FIG. 6 is a flowchart of a travel matching method, in accordance with an embodiment of the present invention.

FIG. 7 is a flowchart of a travel booking method, in accordance with an embodiment of the present invention.

FIGS. 8(a) and 8(b) are a partial screenshot of a travel planning bar configured for planning a honeymoon, in accordance with an embodiment of the present invention.

FIG. 9 is a screenshot of a match results display, in accordance with an embodiment of the present invention.

FIG. 10 is a wire frame mockup of a property details display, in accordance with an embodiment of the present invention.

FIG. 11 is a wire frame mockup of a “getting here” display detailing how to get to a travel property, in accordance with an embodiment of the present invention.

FIG. 12 is a wire frame mockup of an itinerary planning display, in accordance with an embodiment of the present invention.

FIG. 13 is a wire frame mockup of a hotel details display, in accordance with an embodiment of the present invention.

FIG. 14 is a wire frame mockup of a flight details display, in accordance with an embodiment of the present invention.

FIG. 15 is a wire frame mockup of an activity details display, in accordance with an embodiment of the present invention.

FIG. 16 is a wire frame mockup of a rental car details display, in accordance with an embodiment of the present invention.

FIG. 17 is a wire frame mockup of a ground transportation details display, in accordance with an embodiment of the present invention.

FIG. 18 is a wire frame mockup of “make it special” details display, in accordance with an embodiment of the present invention.

FIG. 19 is a flowchart of a travel item selection method for a travel itinerary, in accordance with an embodiment of the present invention.

FIG. 20 is a flowchart of a travel booking method, in accordance with an embodiment of the present invention.

FIG. 21 is a block diagram of an example architecture of the travel planning server, in accordance with an embodiment of the present invention.

### DETAILED DESCRIPTION

The following description is provided to enable any person skilled in the art to make and use the invention. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features, and teachings disclosed herein.

Various system elements, components, tools, etc. are described with reference to a honeymoon embodiment. One skilled in the art will recognize that the system can be used for other purposes, e.g., anniversaries, summer vacations, work travel, etc.

### Travel Planning Network System

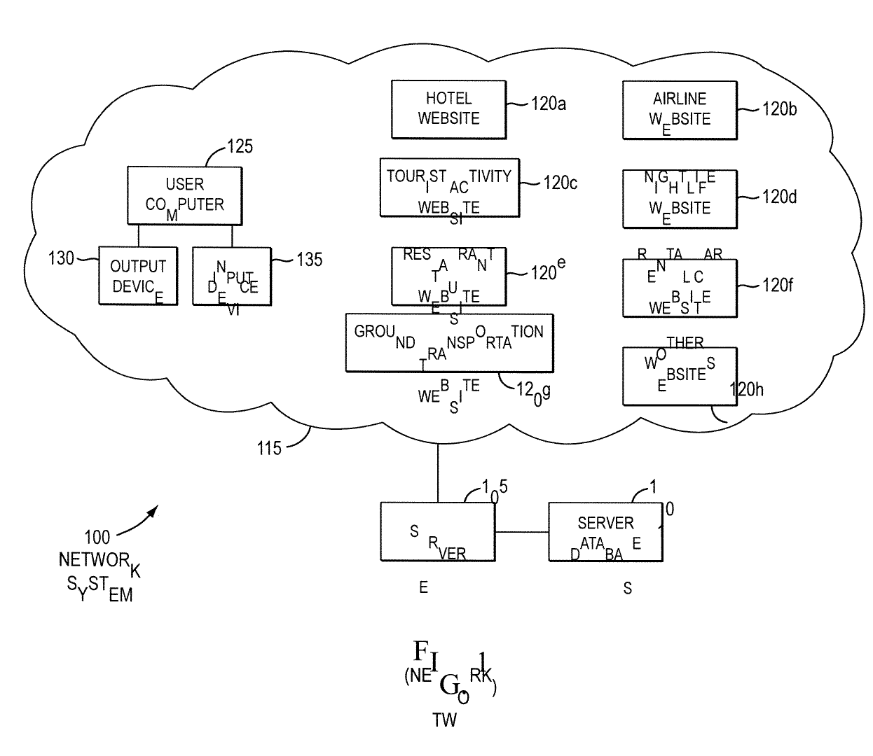

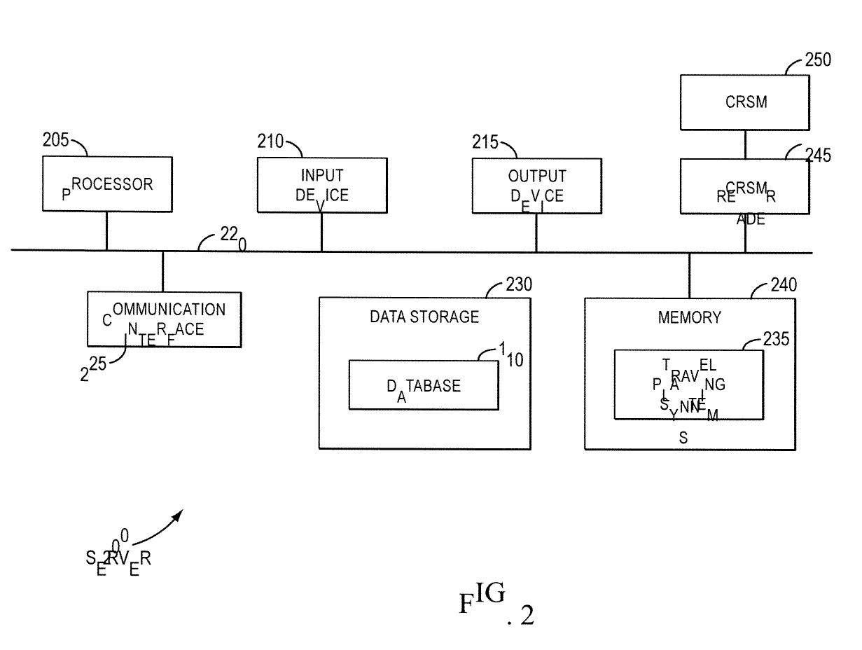

FIG. 1 is a block diagram of a travel planning network system 100, in accordance with an embodiment of the present invention. The travel planning network system 100 comprises a travel planning server 105 coupled to a travel planning database 110 and a wide-area network 115, such as the Internet.

In one embodiment, the travel planning server 105 includes hardware, software, and/or firmware generally operative to navigate to one or more travel websites 120 on the wide-area network 115, to capture content therefrom, to store the content in the travel planning database 110, and to transmit the content to one or more user computers 125. In some embodiments, the user computers 125 may include mobile devices. The travel websites 120 may include hotel websites 120a, airline websites 120b, tourist and other activity websites 120c, nightlife websites 120d, restaurant websites 120e, rental car websites 120f, ground transportation websites 120g, and other websites 120h. A single travel website 120 may provide a combination of travel services (e.g., a single travel website 120 may combine elements of a hotel website 120a, an airline website 120b, and a rental car website 120f.) Each user computer 125 may comprise an output device 130 (such as a cathode ray tube display or a liquid crystal display) and an input device 135 (such as a keyboard or mouse).

### Travel Planning Server

FIG. 2 is a block diagram of a travel planning server 200, in accordance with an embodiment of the present invention. The travel planning server 200 includes a processor 205, such as an Intel Pentium® microprocessor or a Motorola Power PC® microprocessor, coupled to a communications channel 220. The travel planning server 200 further includes an input device 210 (such as a keyboard or mouse), an output device 215 (such as a cathode ray tube display or a liquid crystal display), a communications device 225, a data storage device 230 (such as a magnetic disk), and memory 235 (such as Random-Access Memory (RAM)), each coupled to the communications channel 220. The communications interface 225 may be coupled to the wide-area network 115. One skilled in the art will recognize that, although the data storage device 230 and memory 235 are illustrated as different units, the data storage device 230 and memory 235 can be parts of the same unit, distributed units, virtual memory, etc. Further, it will be appreciated that the term “memory” herein is intended to cover all data storage media whether permanent or temporary.

As shown, the data storage device 230 stores the travel planning database 110, and the memory 235 stores a travel planning system 240. The data storage device 230 and/or the memory 235 may also store an operating system (not shown), such as Microsoft Windows Vista, Linux, the IBM OS/2 operating system, the MAC OS, or the UNIX operating system. It will be appreciated that embodiments of the present invention may also be implemented on platforms and operating systems other than those mentioned. An embodiment of the present invention may be written using JAVA, C, C++ language, and/or other programming languages, possibly using object oriented programming methodology. The present invention may be built on Ruby on Rails or using Ajax.

One skilled in the art will recognize that the travel planning server 200 may also include additional components, such as network connections, additional memory, additional processors, LANs, input/output lines for transferring information across a hardware channel, the Internet or an intranet, etc. One skilled in the art will also recognize that the programs and data may be received by and stored in the server in alternative ways. For example, a computer-readable storage medium (CRSM) reader 245, such as a magnetic disk drive, hard disk drive, magneto-optical reader, CPU, etc., may be coupled to the communications channel 220 for reading a computer-readable storage medium (CRSM) 450, such as a magnetic disk, a hard disk, a magneto-optical disk, RAM, etc. Accordingly, the travel planning server 200 may receive programs and/or data via the CRSM reader 245.

### Travel Planning System

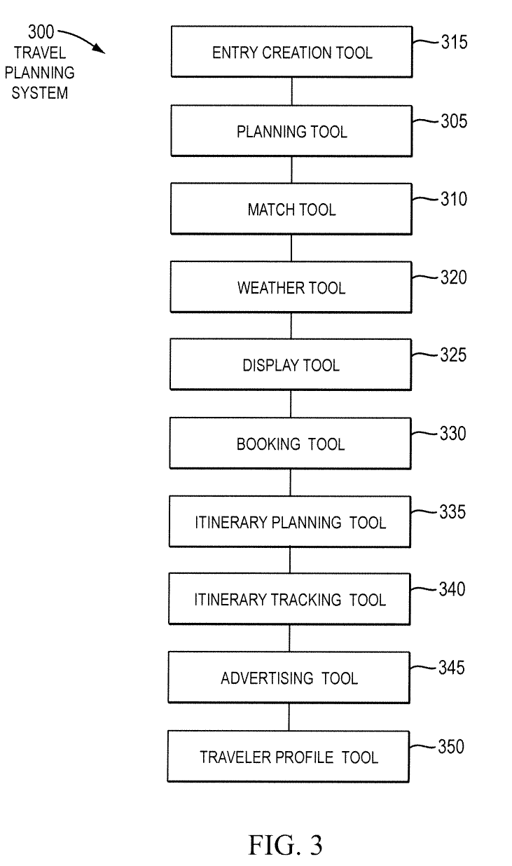

FIG. 3 is a block diagram of a travel planning system 300, in accordance with an embodiment of the present invention. System 300 includes a travel planning tool 305, a match tool 310, an entry creation tool 315, a weather tool 320, a display tool 325, a booking tool 330, an interactive itinerary planning tool 335, an experience planning tool 340, an advertising and promotion tool 345, and a traveler profile tool 350.

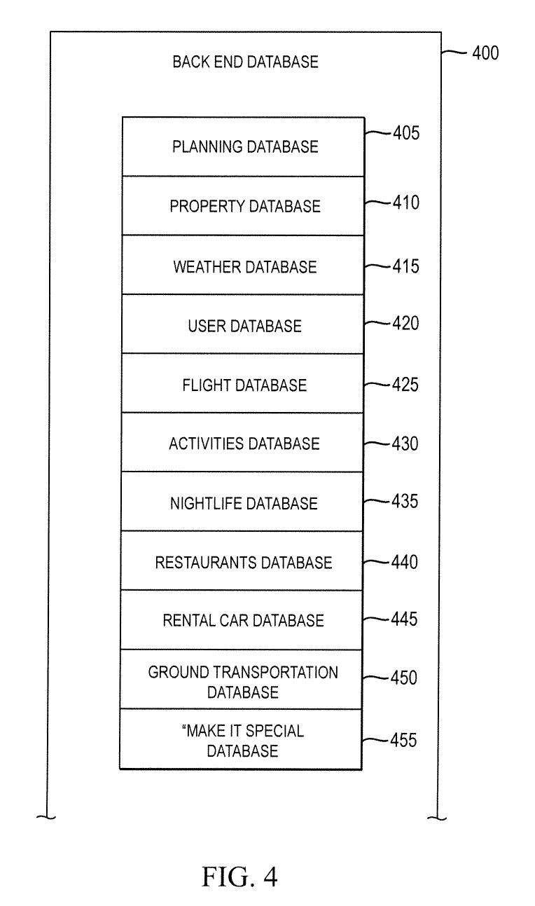

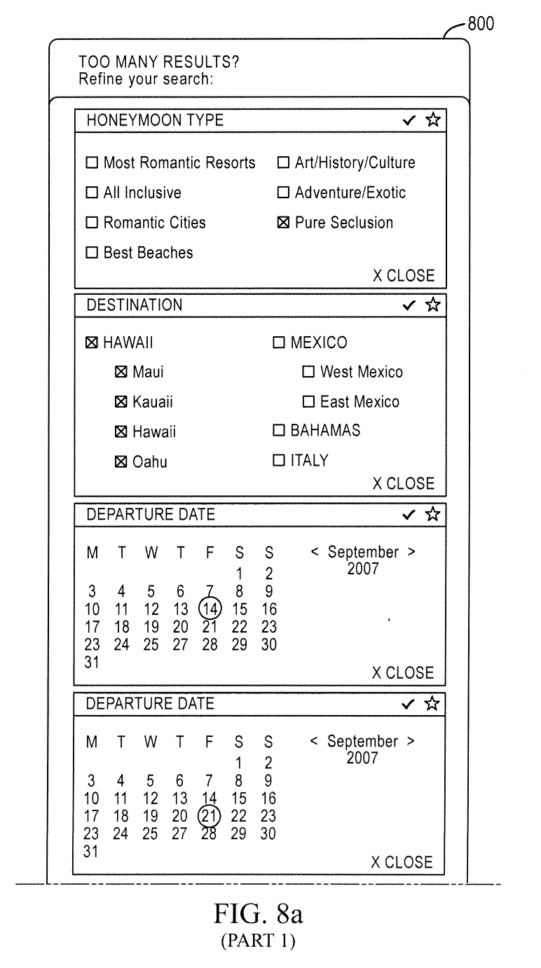

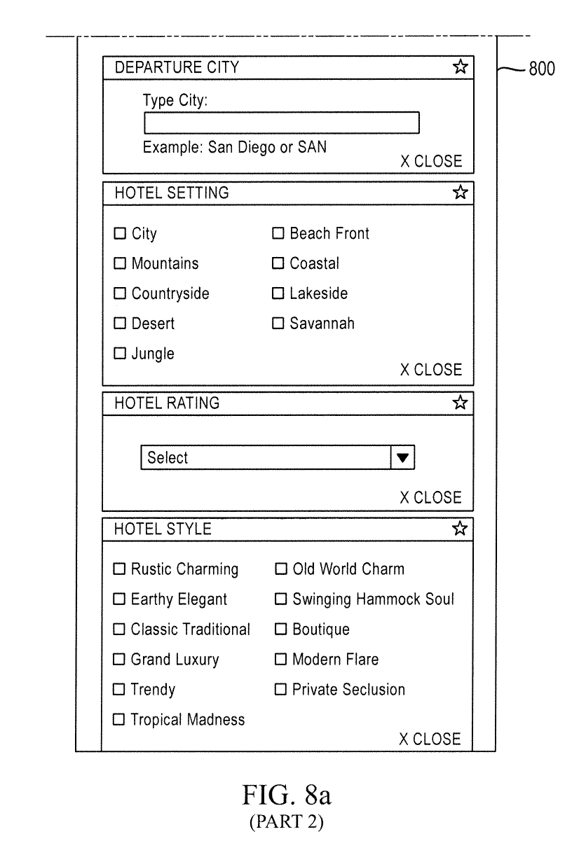

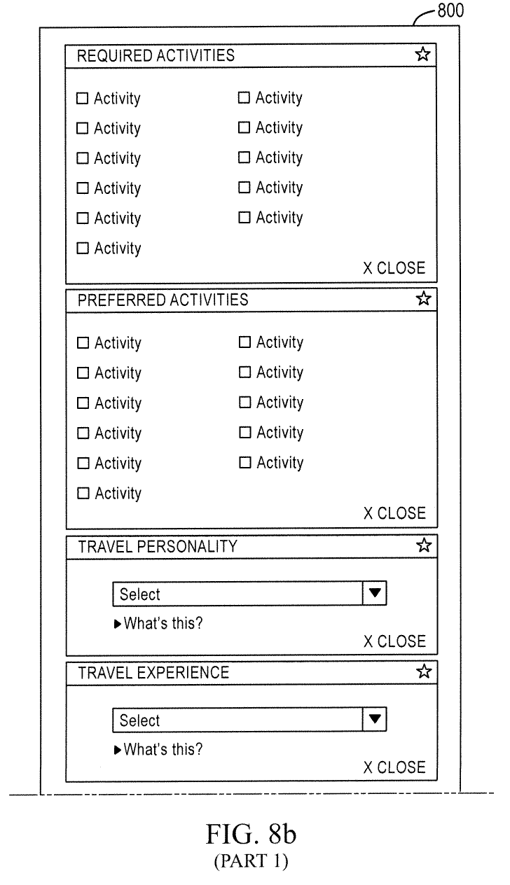

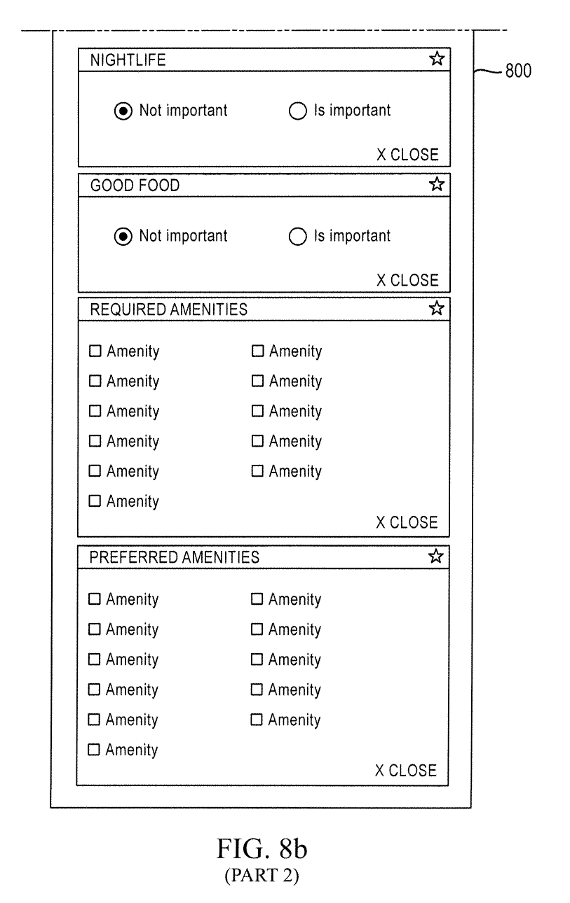

The travel planning tool 305 includes hardware, software, and/or firmware operative to transmit a set of travel planning questions and/or travel planning options to a user computer 125 and to receive a set of travel planning answers and/or travel planning choices from the user computer 125. The travel planning questions and travel planning options may be displayed on the output device 130 of the user computer 125 in the form of a travel planning bar (FIGS. 8(a) and 8(b)). The travel planning answers and/or travel planning choices may be stored in a travel planning database 405 (FIG. 4). Questions/answers and options/choices may relate to specific information (such as departure date, departure city, return date, etc.) and/or attribute information (desired activities desired nightlife, desired travel type, etc.). Generically, questions/answers, options/choices, and/or any other format can generically be termed “travel information requests” and “travel information responses.”

FIGS. 8(a) and 8(b) are a partial screenshot of a travel planning bar 800 configured for planning a honeymoon, in accordance with an embodiment of the present invention. Using the travel planning bar 800, a prospective traveler may choose from among a menu of travel planning questions and travel planning option sets, and submit a set of travel planning answers and/or travel planning choices corresponding to what the prospective traveler wants in a travel experience. The prospective traveler may provide the travel planning answers and/or travel planning choices all at once in a single session or may spread out the answers and choices over a plurality of sessions.

The prospective traveler may choose to submit travel planning answers for only some or none of the travel planning questions, and may choose to submit travel planning choices for only some or none of the travel planning option sets. Thus, a prospective traveler may specify certain travel elements, but allow the travel planning system 300 to choose or recommend a destination and/or a set of travel dates for the travel experience.

The prospective traveler may choose to invite at least a second traveler to submit his or her travel planning answers for only some or none of the travel planning questions, and to choose to submit travel planning choices for only some or none of the travel planning option sets. Thus, a prospective traveler may allow the travel planning system 300 to choose or recommend a destination and/or a set of travel dates for the travel experience based on the combined submissions of all travelers. The prospective traveler may select different methods of sharing the information, such as using a web form to send an e-mail, or copying and pasting a URL into an email or other third party communications tool.

The travel planning system 300 may recommend or not recommend travel destinations based upon data and knowledge about those destinations contained in the back end database 400. This data and knowledge may pertain to information about a travel destination's attributes, weather and environment, natural disasters, and/or social/political situations that could make a destination undesirable for a particular traveler or group of travelers. For example, the travel planning system 300 might not recommend travel properties in hurricane areas during hurricane season, even if the travel property perfectly matched the travel planning answers and travel planning choices submitted by a prospective traveler. As another example, the travel planning system 300 might not recommend a travel property located in an area that is experiencing civil unrest or excessive levels of crime, violence, or disease, even if the travel property might otherwise match the travel planning answers and travel planning choices submitted by a prospective traveler.

As shown in FIGS. 8(a) and 8(b), the prospective traveler may choose one or more honeymoon types (e.g., “most romantic resorts,” “all inclusive,” “romantic cities,” “best beaches,” “art/history/culture,” “adventure/exotic,” “pure seclusion”), one or more destinations (e.g., Hawaii, Mexico, the Bahamas, Italy), a departure date, a return date, a departure city (e.g., San Diego), one or more hotel settings (e.g., city, mountains, countryside, desert, jungle, beach front, coastal, lakeside, savannah), a hotel rating (e.g., “three stars and above,” “four stars and above,” “five stars”), one or more hotel styles (e.g., “rustic charming,” “earthy elegant,” “classic traditional,” “grand luxury,” “trendy,” “tropical madness,” “old world charm,” “swinging hammock soul,” “boutique,” “modern flare,” “private seclusion”), one or more required activities, one or more preferred activities, a travel personality, a travel experience, a nightlife choice (e.g., “not important,” “is important”), a “good food” choice (e.g., “not important,” “is important”), one or more required amenities, and one or more preferred amenities. Examples of “hotel information” include rating, amenities, hotel setting, hotel style, etc. In one embodiment, the travel planning tool 305 is configured to allow a prospective traveler to send a request to one or more companion travelers to gather the preferences of the companion or companions, e.g., bride preferences, regarding the above options.

The user may choose to provide information about his or her personality that will assist the travel planning system 300 in making travel recommendations. The travel planning tool 305 may collect this information through surveys, quizzes, polls, profile questionnaires, ratings, monitoring of the user's website activity (e.g., what web pages or sections the user downloads and/or spends the most time on), monitoring of the user's online purchases, and/or collecting other information that the user explicitly or implicitly provides during his or her interactions with the travel planning system. The travel planning tool 305 might collect this information through direct questions (e.g., “Do you prefer beaches or mountains?”) and/or through inference (e.g., a user who reads an article about beach workouts might prefer a travel property having convenient access to a swimmable beach).

A user may make a travel planning choice by selecting a corresponding check box using the input device 135 (e.g., the honeymoon type, destination, hotel setting, hotel style, required activities, preferred activities, required amenities, and preferred amenities option sets), by choosing from among a set of pre-defined attribute options displayed on a drop-down menu (e.g., the hotel rating, travel personality, and travel experience option sets), or by selecting from among a set of radio buttons (e.g., the nightlife and “good food” option sets). In one embodiment, a travel planning option set may be configured so that a plurality of travel planning options may be chosen all at once. For example, as shown in FIGS. 8(a) and 8(b), a user may choose among the individual Hawaiian islands for the travel destination, or may select “Hawaii” to choose all of the Hawaiian islands. Surveys, quizzes, polls, profile questionnaires, and keyword searches may similarly be configured so that a plurality of options/answers may be chosen all at once.

A user may enter a travel planning answer by typing in the answer (e.g., typing in a departure city) or by selecting a date on a calendar (e.g., choosing a departure date or a return date).

A user may also enter a travel planning answer by typing in one or more keywords (e.g., “golf,” “organic,” “mud spa treatment,” etc.). The travel planning system 300 may use these keywords to select and/or rate travel properties. In doing so, the travel planning system 300 may consult descriptions, reviews, tags, and other data collected about the various travel properties in the travel property database 410.

The travel planning bar 800 is configured to display a star beside each travel planning question and travel planning option set. Using the input device 135, a user may select a star to collapse (hide) or expand (show) the corresponding travel planning question or travel planning option set. Selecting “X CLOSE” also collapses the corresponding travel planning question or travel planning option set.

The match tool 310 includes hardware, software, and/or firmware operative to select and rate hotels, resorts, and other travel properties based upon the travel planning answers and/or travel planning choices received from the user computer 125. The output of the match tool 310 is an ordered set of travel properties that meet the essential criteria specified by the travel planning answers and/or travel planning choices. In one embodiment, the match tool 310 is configured to sort travel properties by relevancy (match score), with the highest ranked properties shown first. The match tool 310 may allow the user to re-sort the list of travel properties based upon relevant criteria, such as price, distance, or ratings, to assist the user in finding the travel property that best matches the user's experience and other constraints. The user may edit his or her travel planning answers and travel planning choices to see how changes in the answers and choices affect the travel recommendations.

In one embodiment, the match tool 310 is configured to select and rate travel properties by separating the travel planning option sets into three general classes: Boolean, rating-based, and accumulative.

A Boolean attribute option set represents an attribute that, if chosen by the prospective traveler, eliminates all travel properties that lack the chosen attribute. For example, if a prospective traveler chooses “is important” for the nightlife option set, then the match tool 310 will eliminate all travel properties that lack convenient access to nightlife activities. Similarly, if a prospective traveler chooses “is important” for the “good food” option set, then the match tool 310 will eliminate all travel properties that lack convenient access to good restaurants.

A rating-based attribute option set represents an attribute having a range of values from which the prospective traveler may choose. The match tool 310 will eliminate all travel properties having a rating-based attribute value less than the chosen value. For examples if a prospective traveler chooses “four stars and above” for the hotel rating option set, then the match tool 310 will eliminate all travel properties that lack a hotel rating of four or more stars.

An accumulative attribute option set affects the rating that the match tool 310 assigns to a travel property that survives elimination in light of the Boolean attribute choices and rating-based attribute choices made by the prospective traveler. In one embodiment, the match tool 310 compares the accumulative attribute choices made by the prospective traveler to the accumulative attributes associated with the travel property, and assigns a higher attribute rating to a travel property having a higher number of accumulative attribute matches. The match tool 310 weights accumulative attribute option sets equally, with no accumulative attribute option set having a greater effect on a travel property's rating than any other.

In one embodiment, there are three subclasses of accumulative attribute option sets: Required Any, Required All, and Required None.

A Required Any accumulative attribute option set is one for which the user may make one or more attribute choices. A travel property must have at least one of the chosen attributes to survive elimination. The match tool 310 will assign a higher attribute rating to a travel property having a higher number of Required Any accumulative attribute matches. For example, if a prospective traveler chooses “city” and “desert” for the hotel setting option set, then the match tool 310 will eliminate all travel properties that are not located in either a city or a desert. The match tool 310 will assign a higher attribute rating to a travel property located in both a city and a desert (e.g., a hotel located in Las Vegas, Nev.) than it will to a travel property located in a city but not in a desert (e.g., a hotel located in Seattle, Wash.).

A Required All accumulative attribute option set is one for which the user may make one or more attribute choices. A travel property must have all of the chosen attributes to survive elimination. For example, if a prospective traveler chooses “snorkeling,” “swimming,” “diving,” and “horseback riding” for the required activities option set, then the match tool 310 will eliminate all travel properties that lack convenient access to these activities.

A Required None accumulative attribute option set is one for which the user may make one or more attribute choices. A travel property need not have any of the chosen attributes to survive elimination. The match tool 310, however, will assign a higher attribute rating to a travel property having a higher number of Required None accumulative attribute matches. For example, if a prospective traveler chooses “snorkeling,” “swimming,” “diving,” and “horseback riding” for the preferred activities option set, then the match tool 310 will assign a higher attribute rating to a travel property having convenient access to all of these activities than it will to a travel property having convenient access only to horseback riding.

The match tool 310 may also be configured to select and rate travel properties based upon one or more keywords typed in by the user. The match tool 310 may assign a higher rating to a travel property having one or more instances of the keyword or keywords in its description, tags, reviews, and/or other descriptive information in the travel property database 410. The match tool 310 may assign a lower rating to a travel property for which the keyword is contained in the travel property database 410 in a negative context. For example, if the user enters “golf” as a keyword and the property description in the travel property database 410 includes the text “This resort has a world-class 36-hole golf course” in the description, then the match tool 310 will increase the rating of that travel property. If the user enters “golf” as a keyword and a review of the property in the travel property database 410 states, “The golf course was in poor condition,” then the match tool 310 will decrease the rating of that travel property.

The match tool 310 may suggest the most popular tags/keywords to the user in a “tag cloud.” A tag cloud may list some of the most popular or relevant tags/keywords, typically displaying the most popular tags/keywords in a larger font size. The user may select one or more of the keywords/tags using the input device 135, and the match tool 310 will select and/or rate the travel properties in the travel property database 410 that are associated with the selected keywords/tags.

The match tool 310 may be configured to qualitatively score any of the attribute options, such that the property rating may depend upon how well the property satisfies the attribute. A travel property might earn a higher or lower rating depending upon the proximity, accessibility, density, quality, popularity or other aspects of the attribute vis-à-vis the travel property. For example, if a prospective traveler chooses “horseback riding” as a desired activity, a first travel property that has horses and guides on site might receive a higher attribute rating (e.g., a 100 percent rating) than a second travel property that is equipped to set up a horseback riding activity located an hour's drive from the travel property (e.g., a 75 percent rating). Similarly, the second travel property might receive a higher attribute rating than a third travel property, for which horseback riding is available in the general area but the property is not equipped to set up the activity (e.g., a 50 percent rating).

The match tool 310 may also consult a user's profile in rating a travel property. In one embodiment, the match tool 310 may use profile information to distinguish between travel properties that received equal ratings based upon the user's travel planning answers and travel planning choices. For example, based upon the user's travel planning answers and travel planning choices, two properties might receive the same rating, but one property has been viewed, booked, and rated favorably by other users having similar profiles. The match tool 310 may present this information to the user to help the user select a travel property. The match tool 310 might also use profile information to recommend travel destinations when a user has not provided any travel planning answers and/or travel planning choices. For example, before a user has specified what type of travel experience the user is seeking, the match tool 310 could consult the user database 420 to determine which specific travel destinations that users having similar profiles have enjoyed, and recommend those destinations. This recommendation may be provided while the user is using the travel planning system 300, or the recommendation may be provided to the user separately via e-mail, direct mail, and/or other forms of marketing.

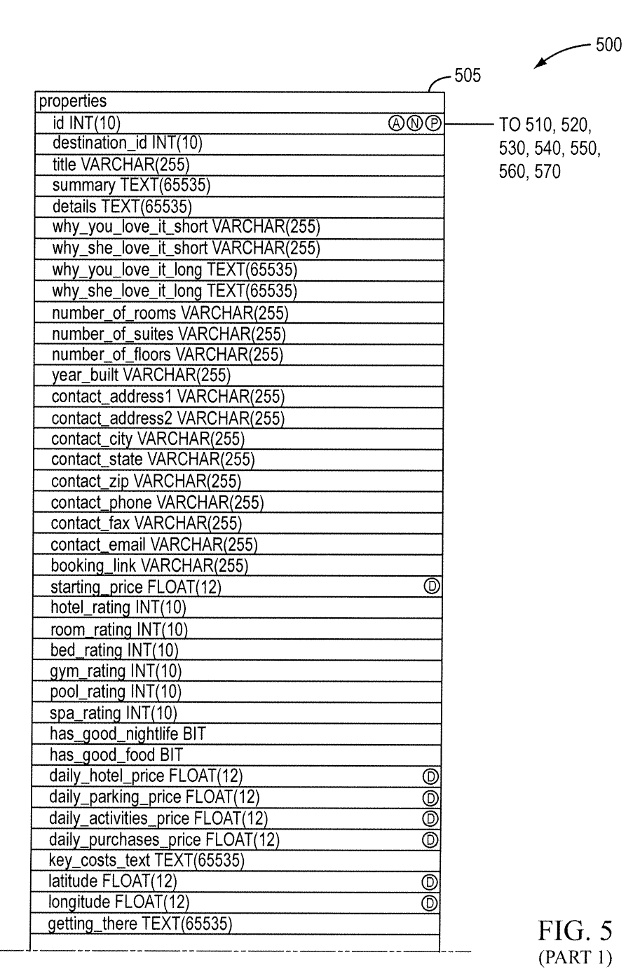

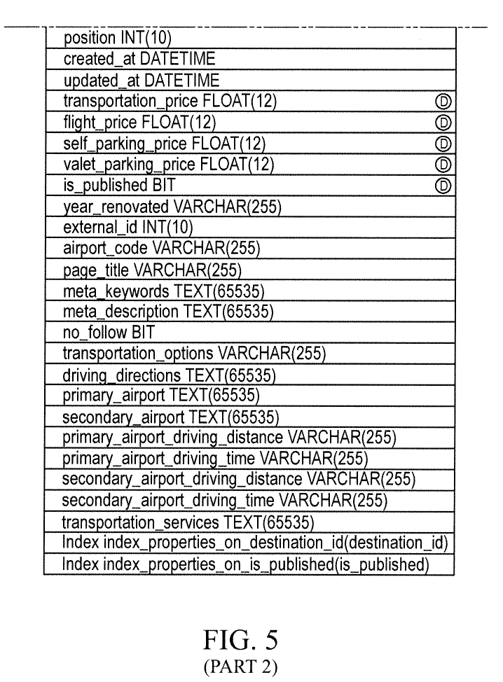

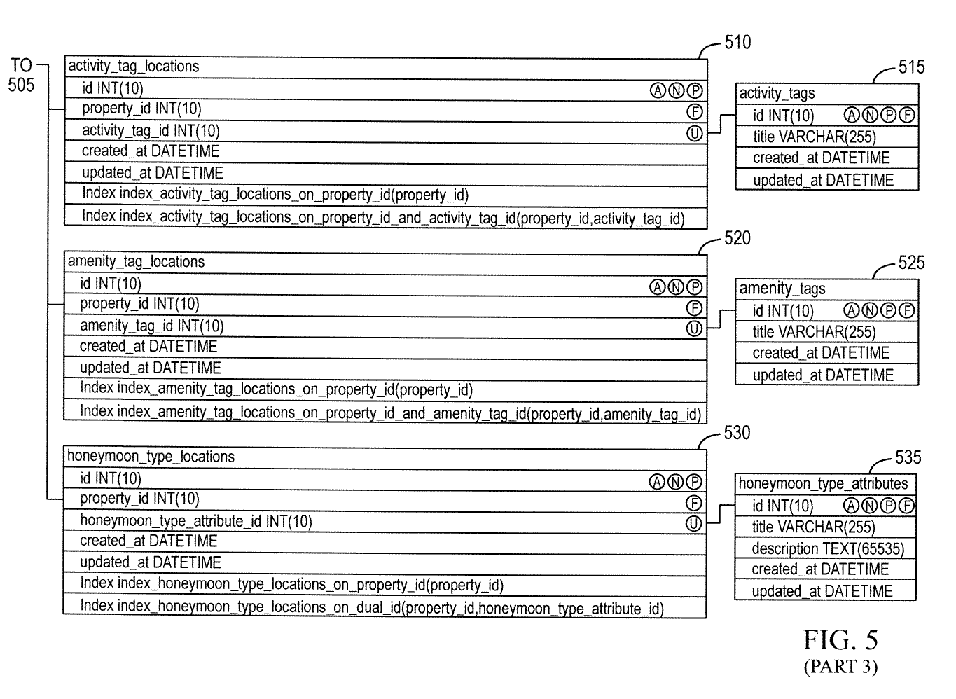

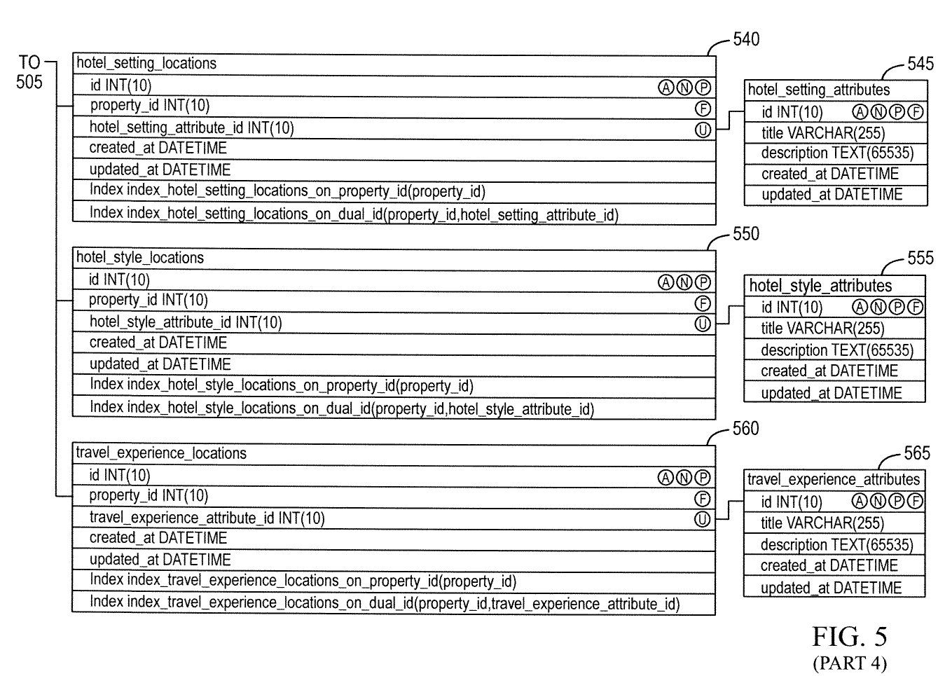

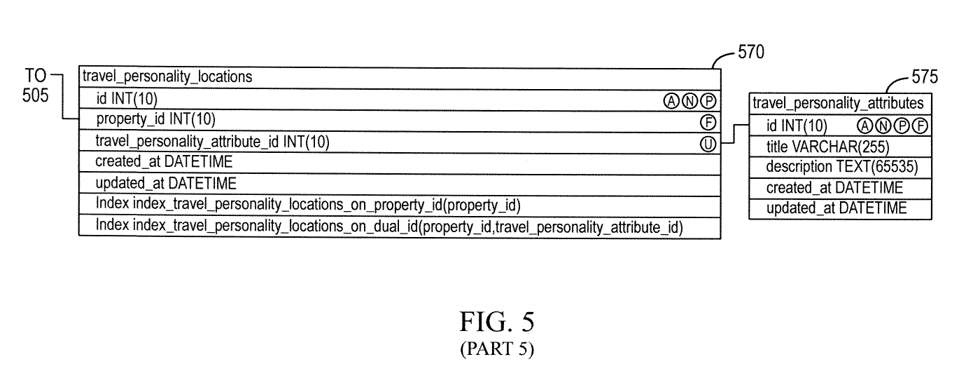

In selecting and rating the travel properties, the match tool 310 may consult a travel property database 410. FIG. 5 is a block diagram of a travel property database structure 500, in accordance with an embodiment of the present invention, that may be stored in the property database 410. In one embodiment, the travel property database structure 500 comprises property entries (such as property entry 505), activity tag location entries (such as activity tag location entry 510), activity tag entries (such as activity tag entry 515), amenity tag location entries (such as amenity tag location entry 520), amenity tag entries (such as amenity tag entry 525), honeymoon type location entries (such as honeymoon type location entry 530), honeymoon type attribute entries (such as honeymoon type attribute entry 535), hotel setting location entries (such as hotel setting location entry 540), hotel setting attribute entries (such as hotel setting attribute entry 545), hotel style location entries (such as hotel style location entry 550), hotel style attribute entries (such as hotel style attribute entry 555), travel experience location entries (such as travel experience location entry 560), travel experience attribute entries (such as travel experience attribute entry 565), travel personality location entries (such as travel personality location entry 570), and travel personality attribute entries (such as travel personality attribute entry 575).

In one embodiment, a property entry 505 comprises data pertaining to the following information about a particular travel property a property identification number; a destination identification number; a property title; a property summary; property details; a short description of why a man would like the property; a short description of why a woman would like the property; a long description of why a man would like the property; a long description of why a woman would like the property; the number of rooms that the property has; the number of suites that the property has; the number of floors that the property has; the year that the property was built; the property's address, city, state, and zip code; the property's telephone number; the property's facsimile number; the property's e-mail address; a web address corresponding to a web page at which a prospective traveler could book a room at the property; the starting price of rooms at the property; a hotel rating; a room rating; a bed rating; a gym rating; a pool rating, a spa rating; an indication of whether the property has convenient access to good nightlife; an indication of whether the property has convenient access to good food; a daily hotel price; a daily parking price; a daily activities price; a daily purchases price; a description of the key costs associated with staying at the property; the geographic latitude of the property; the geographic longitude of the property; a description of how to get to the property; the date and time at which the property entry was created; the date and time at which the property entry was last updated; a transportation price; a flight price; a self-parking price; a valet parking price; an indication of whether the property entry should be made publicly available; the year that the property was last renovated; an external property identification number; the airport code for the airport that is closest to the property; a page title; keywords describing the property; a metadata description of the property; transportation options to the property; driving directions to the property; a primary airport serving the property; a secondary airport serving the property; the approximate driving distance to the primary airport; the approximate driving time to the primary airport; the approximate driving distance to the secondary airport the approximate driving time to the secondary airport; and a description of transportation services.

One or more activity tag location entries 510 may be associated with a property entry 505. In one embodiment, an activity tag location entry 510 comprises data pertaining to the following information about an activity available at a particular travel property: an activity tag location identification number; the property identification number; an activity tag identification number; the date and time at which the activity tag location entry was created; and the date and time at which the activity tag location entry was last updated. The activity tag identification number may be associated with an activity tag entry 515. An activity tag entry 515 comprises data pertaining to the following information about an activity: the activity tag identification number; an activity title; the date and time at which the activity tag entry was created; and the date and time at which the activity tag entry was last updated. An activity (such as snorkeling, swimming, diving, horseback riding, etc.) may thus be associated with a travel property in the travel property database 410.

One or more amenity tag location entries 520 may be associated with a property entry 505. In one embodiment, an amenity tag location entry 520 comprises data pertaining to the following information about an amenity available at a particular travel property: an amenity tag location identification number; the property identification number; an amenity tag identification number; the date and time at which the amenity tag location entry was created; and the date and time at which the amenity tag location entry was last updated. The amenity tag identifications number may be associated with an amenity tag entry 525. An amenity tag entry 525 comprises data pertaining to the following information about an amenity: the amenity tag identification number; an amenity title; the date and time at which the amenity tags entry was created; and the date and time at which the amenity tag entry was last updated. An amenity (such as a spa, valet parking, an in room high-speed Internet connection, etc.) may thus be associated with a travel property in the travel property database 410.

One or more honeymoon type location entries 530 may be associated with a property entry 505. In one embodiment, a honeymoon type location entry 530 comprises data pertaining to the following information about a honeymoon type that may be compatible with staying at a particular travel property: a honeymoon type location identification number; the property identification number; a honeymoon type attribute identification number; the date and time at which the honeymoon type location entry was created; and the date and time at which the honeymoon type location entry was last updated. The honeymoon type attribute identification number may be associated with a honeymoon type attribute entry 535. A honeymoon type attribute entry 535 comprises data pertaining to the following information about a honeymoon type attribute: the honeymoon type attribute identification number; a honeymoon type attribute title; a honeymoon type attribute description; the date and time at which the honeymoon type attribute entry was created; and the date and time at which the honeymoon type attribute entry was last updated. A honeymoon type attribute (such as “most romantic resorts,” “all inclusive,” “romantic cities,” “best beaches” “art/history/culture,” “adventure/exotic,” “pure seclusion,” etc.) may thus be associated with a travel property in the travel property database 410.

One or more hotel setting location entries 540 may be associated with a property entry 505. In one embodiment, a hotel setting location entry 540 comprises data pertaining to the following information about a hotel setting that a prospective traveler may expect to find when staying at a particular travel property: a hotel setting location identification number; the property identification number; a hotel setting attribute identification number; the date and time at which the hotel setting location entry was created; and the date and time at which the hotel setting location entry was last updated. The hotel setting attribute identification number may be associated with a hotel setting attribute entry 545. A hotel setting attribute entry 545 comprises data pertaining to the following information about a hotel setting attribute: the hotel setting attribute identification number; a hotel setting attribute title; a hotel setting attribute description; the date and time at which the hotel setting attribute entry was created; and the date and time at which the hotel setting attribute entry was last updated. A hotel setting attribute (such as city, mountains, countryside, desert, jungle, beach front, coastal, lakeside, savannah, etc.) may thus be associated with a travel property in the travel property database 410.

One or more hotel style location entries 550 may be associated with a property entry 505. In one embodiment, a hotel style location entry 550 comprises data pertaining to the following information about a hotel style that a prospective traveler may expect to find when staying at a particular travel property: a hotel style location identification number; the property identification number; a hotel style attribute identification number; the date and time at which the hotel style location entry was created; and the date and time at which the hotel style location entry was last updated. The hotel style attribute identification number may be associated with a hotel style attribute entry 555. A hotel style attribute entry 555 comprises data pertaining to the following information about a hotel style attribute: the hotel style attribute identification number; a hotel style attribute tile; a hotel style attribute description; the date and time at which the hotel style attribute entry was created; and the date and time; at which the hotel style attribute entry was last updated. A hotel style attribute (such as “rustic charming,” “earthy elegant,” “classic traditional,” “grand luxury,” “trendy,” “tropical madness,” “old world charm,” “swinging hammock soul,” “boutique,” “modern flare,” “private seclusion,” etc.) may thus be associated with a travel property in the travel property database 410.

One or more travel experience locating entries 560 may be associated with a property entry 505. In one embodiment, a travel experience location entry 560 comprises data pertaining to the following information about the levels of travel experience that might be appropriate for staying at a particular travel property: a travel experience location identification number; the property identification number; a travel experience attribute identification number; the date and time at which the travel experience location entry was created; and the date and time at which the travel experience location entry was last updated. The travel experience attribute identification number may be associated with a travel experience attribute entry 565. A travel experience attribute entry 565 comprises data pertaining to the following information about a travel experience attribute: the travel experience attribute identification number; a travel experience attribute title; a travel experience attribute description; the date and time at which the travel experience attribute entry was created; and the date and time at which the travel experience attribute entry was last updated. A travel experience attribute (such as “savvy,” “competent,” “novice,” etc.) may thus be associated with a travel property in the travel property database 410.

One or more travel personality location entries 570 may be associated with a property entry 505. In one embodiment, a travel personality location entry 570 comprises data pertaining to the following information about which travel personalities might enjoy staying at a particular travel property: a travel personality location identification number; the property identification number; a travel personality attribute identification number; the date and time at which the travel personality location entry was created; and the date and time at which the travel personality location entry was last updated. The travel personality attribute identification number may be associated with a travel personality attribute entry 575. A travel personality attribute entry 575 comprises data pertaining to the following information about a travel personality attribute: the travel personality attribute identification number; a travel personality attribute title; a travel personality attribute description; the date and time at which the travel personality attribute entry was created; and the date and time at which the travel personality attribute entry was last updated. A travel personality attribute (such as “cultured traveler,” “rugged adventurer traveler,” “pampered traveler,” “rest and recreations traveler,” “learner traveler,” etc.) may thus be associated with a travel property in the travel property database 410.

The entries in the travel property database structure 500 may be entered using the entry creation tool 315. The entry creation tool 315 includes hardware, software, and/or firmware operative to receive entry data via the input device 210 and to store the data in the appropriate parts of the travel property database structure 500. Travel property attributes can thus be indexed for search and match purposes.

The weather tool 320 includes hardware, software, and/or firmware operative to profile weather-related information relevant to the travel experiences that a person might receive at a given travel property. This information includes low, high, and average temperatures throughout the year; the times of the year that represent a high risk for a bad travel experience (e.g., hurricane season); and the times of the year that represent a high probability for a great travel experience (e.g., typically sunny, not humid, and little chance of rain). The weather tool 320 integrates with the output of the match tool 310 to either filter out travel properties or to increase the rating of a travel property for which weather conditions might impact the quality of the desired experience during the travel period. For instances in which the weather tool 320 does not eliminate a travel property altogether, the weather tool 320 will include weather information about the travel property in the property detail pages displayed to the user. The weather tool 320 thus may be configured to present relevant information about weather expectations and to assist the user in selecting a destination. In one embodiment, the weather tool 320 assigns a “best,” “OK,” or “risky” label to all travel properties output by the match tool 310. In another embodiment, the weather tool 320 transmits to the user computer 125 a map of travel properties having colors keyed to weather type for a chosen travel period. In determining weather information, the weather tool 320 may consult a weather database 415 or a website 120h that provides weather data.

In one embodiment, the weather tool 320 presents average high and low temperatures by month for a given destination to the user in a chart. In a further embodiment, weather information about a travel property may be displayed through a widget that can be added to a separate website. The widget may be configured to provide information about a destination to which a user is traveling or considering traveling.

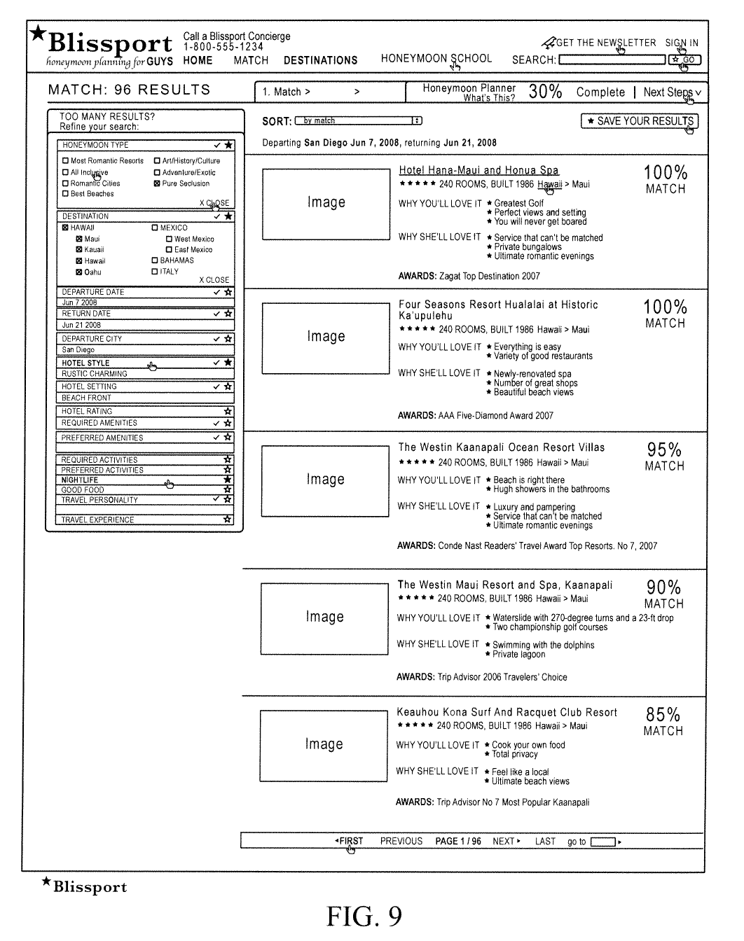

The display tool 325 includes hardware, software, and/or firmware operative to receive the output of the match tool 310 and/or weather tool 320 and to transmit a match results display reflecting the selected and/or rated travel properties to the user computer 125. The display may include text, images, and/or video associated with the travel properties. FIG. 9 is a screenshot of a match results display, in accordance with an embodiment of the present invention.

The booking tool 330 includes hardware, software, and/or firmware operative to receive a booking decision from the user respecting a travel property displayed on the match results display and to book a room at the travel property for the user. The booking tool 330 may also be configured to save data respecting the chosen travel property in a user database 420 for future use.

### Travel Matching Method

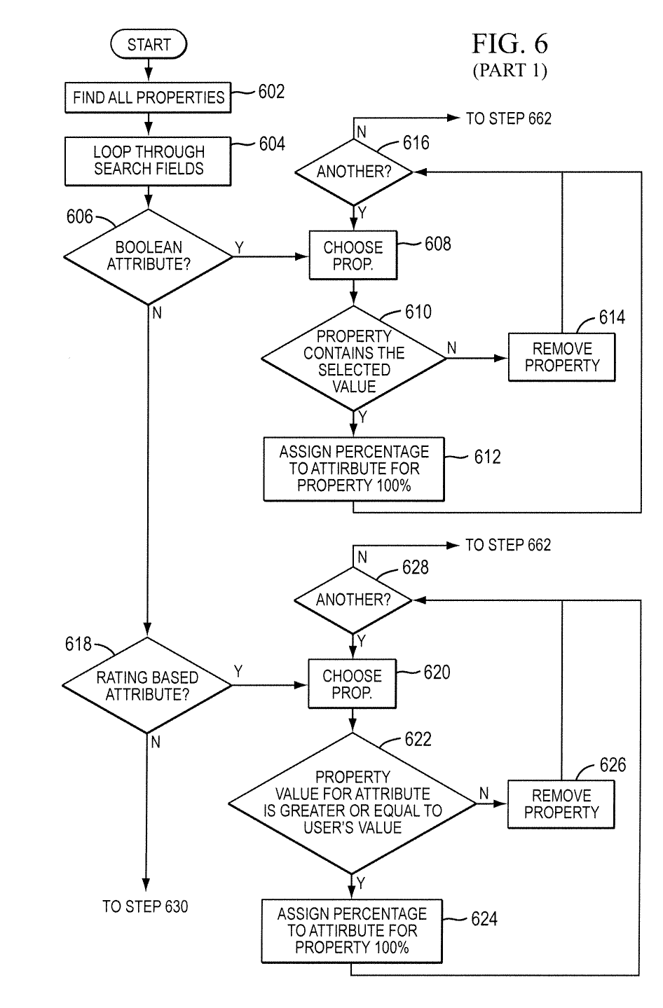

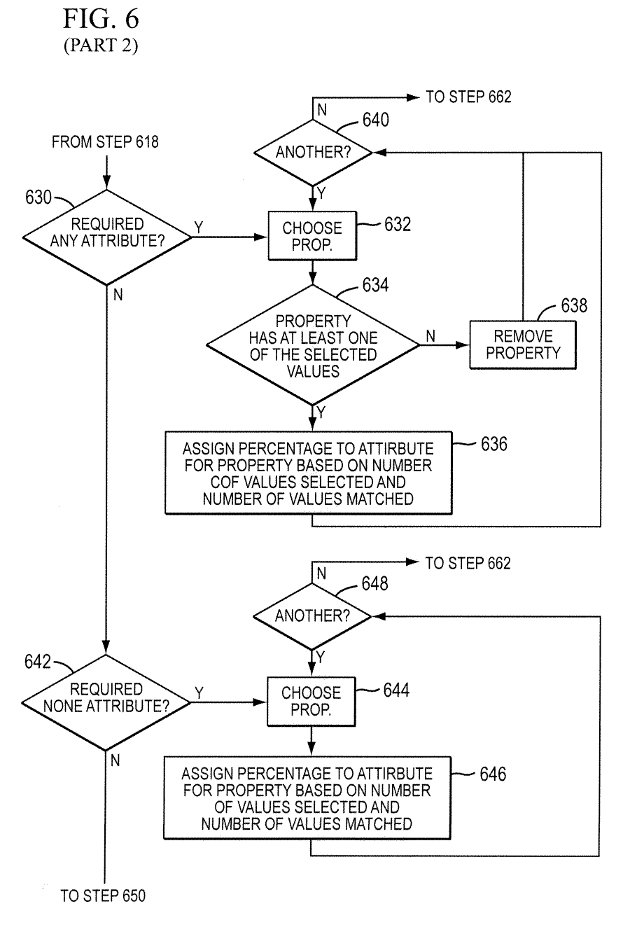

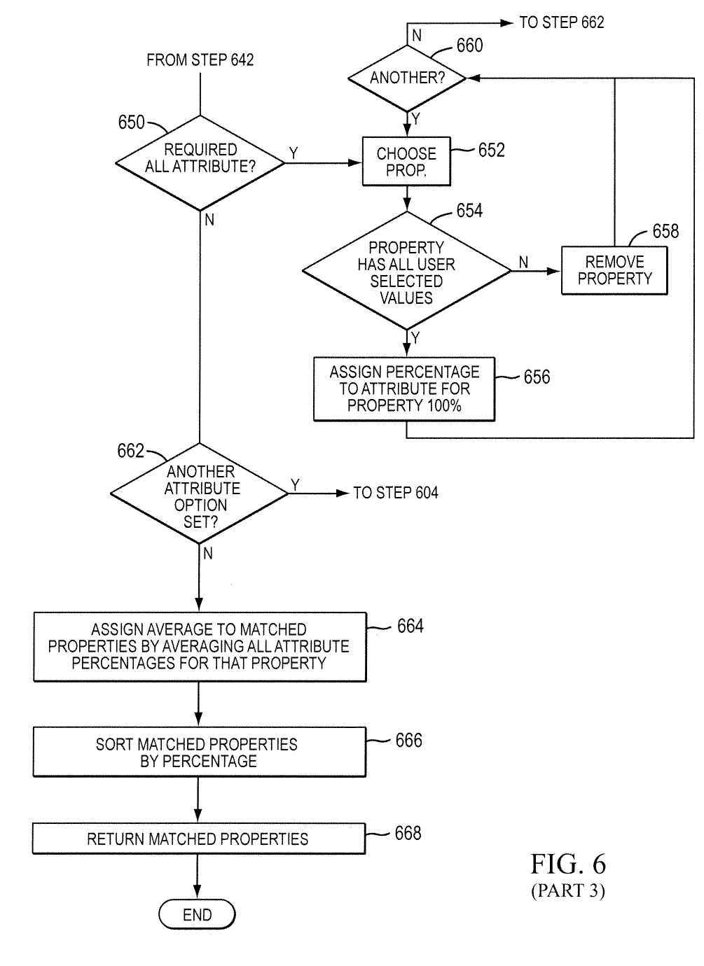

FIG. 6 shows a flowchart of a travel experience matching method 600, in accordance with an embodiment of the present invention. The travel matching method 600 begins in step 602 with the match tool 310 finding the travel property database 410, which contains all properties available for selecting and rating by the match tool, and creating a travel property list. In step 604, the match tool 310 begins serially looping through the travel planning option sets by selecting one of the travel planning option sets presented to the prospective traveler using the planning tool 305.

In step 606, the match tool 310 determines whether the travel planning option set is a Boolean attribute option set. If the travel planning option set is a Boolean attribute option set, then the method 600 proceeds to step 608. If not, then the method 600 proceeds to step 618. In step 608, the match tool 310 chooses a travel property from the travel property list. In step 610, the match tool 310 determines whether the chosen travel property has the travel attribute that the user chose for the Boolean attribute option set. If the chosen travel property does have the chosen attribute, then the method 600 proceeds to step 612. If not, then the method 600 proceeds to step 614. In step 612, the match tool 310 assigns a 100 percent rating to the chosen travel property for the particular travel attribute. The method 600 then proceeds to step 616. In step 614, the match tool 310 removes the chosen travel property from the travel property list. The method 600 then proceeds to step 616. In step 616, the match tool 310 determines whether there is another travel property to process. If there is another travel property to process, then the method 600 returns to step 608. If not, then the method 600 proceeds to step 662.

In step 618, the match tool 310 determines whether the travel planning option set is a rating-based attribute option set. If the travel planning option set is a rating-based attribute option set, then the method 600 proceeds to step 620. If not, then the method 600 proceeds to step 630. In step 620, the match tool 310 chooses a travel property from the travel property list. In step 622, the match tool 310 determines whether the chosen travel property has a rating-based attribute value greater than or equal to the chosen value for the rating-based attribute option set. If the chosen travel property does have a rating-based attribute value greater than or equal to the chosen value, then the method 600 proceeds to step 624. If not then the method 600 proceeds to step 626. In step 624, the match tool 310 assigns a 100 percent rating to the chosen travel property for the particular travel attribute. The method 600 then proceeds to step 628. In step 626, the match tool 310 removes the chosen travel property from the travel property list. The method 600 then proceeds to step 628. In step 628, the match tool 310 determines whether there is another travel property to process. If there is another travel property to process, then the method 600 returns to step 620. If not, then the method 600 proceeds to step 662.

In step 630, the match tool 310 determines whether the travel planning option set is a Required Any accumulative attribute option set. If the travel planning option set is a Required Any accumulative attribute option set, then the method 600 proceeds to step 632. If not, then the method 600 proceeds to step 642. In step 632, the match tool 310 chooses a travel property from the travel property list. In step 634, the match tool 310 determines whether the chosen travel property has at least one of the attributes that the user chose for the Required Any accumulative attribute option set. If the chosen travel property does have at least one of the chosen values, then the method 600 proceeds to step 636. If not, then the method 600 proceeds to step 638. In step 636, the match tool 310 assigns a percentage rating to the chosen travel property for the attribute based upon the number of attribute choices that the user made and the number of attribute choices that the chosen travel property has. For example, if a prospective traveler chooses “city” and “desert” for the hotel setting option set, then in step 636 the match tool 310 will assign a 100 percent rating to a travel property located in both a city and a desert (e.g., a hotel located in Las Vegas, Nev.) and a 50 percent rating to a travel property located in a city but not in a desert (e.g., a hotel located in Seattle, Wash.). After the match tool 310 assigns the rating, the method 600 then proceeds to step 640. In step 638, the match tool 310 removes the chosen travel property from the travel property list. The method 600 then proceeds to step 640. In step 640, the match tool 310 determines whether there is another travel property to process. If there is another travel property to process, then the method 600 returns to step 632. If not, then the method 600 proceeds to step 662.

In step 642, the match tool 310 determines whether the travel planning option set is a Required None accumulative attribute option set. If the travel planning option set is a Required None accumulative attribute option set, then the method 600 proceeds to step 644. If not, then the method 600 proceeds to step 650. In step 644, the match tool 310 chooses a travel property from the travel property list. In step 646, the match tool 310 assigns a percentage rating to the chosen travel property for the attribute based upon the number of attribute choices that the user made and the number of attribute choices that the chosen travel property has. For example, if a prospective traveler chooses “snorkeling,” “swimming,” “diving,” and “horseback riding” for the preferred activities option set, then in step 646 the match tool 310 will assign a 75 percent attribute rating to a travel property having convenient access to snorkeling, swimming, and diving, but not horseback riding). After the match tool 310 assigns the rating, the method 600 then proceeds to step 648. In step 648, the match tool 310 determines whether there is another travel property to process. If there is another travel property to process, then the method 600 returns to step 644. If not, then the method 600 proceeds to step 662.

In step 650, the match tool 310 determines whether the travel planning option set is a Required All accumulative attribute option set. If the travel planning option set is a Required All accumulative attribute option set, then the method 600 proceeds to step 650. If not, then the method 600 proceeds to step 662. In step 652, the match tool 310 chooses a travel property from the travel property list. In step 654, the match tool 310 determines whether the chosen travel property has all of the travel attributes that the user chose for the Required All accumulative attribute option set. If the chosen travel property does have all of the chosen attributes, then the method 600 proceeds to step 656. If not, then the method 600 proceeds to step 658. In step 656, the match tool 310 assigns a 100 percent rating to the chosen travel property for the particular travel attribute. The method 600 then proceeds to step 660. In step 658, the match tool 310 removes the chosen travel property from the travel property list. The method 600 then proceeds to step 660. In step 660, the match tool 310 determines whether there is another travel property to process. If there is another travel property to process, then the method 600 returns to step 652. If not, then the method 600 proceeds to step 662.

In step 662, the match tool 310 determines whether there is another travel planning option set to process. If there is another travel planning option set to process, then the method 600 returns to set 604. If not, then the method proceeds to step 664.

In step 664, the match tool 310 assigns an average rating to each travel property remaining on the travel property list by averaging all attribute rating percentages for that travel property. In step 666, the match tool 310 sorts each remaining travel property by the average rating assigned (e.g., a travel property having an average rating of 75 percentages before a travel property having an average rating of 25 percent). In step 668, the display tool 325 transmits a match results display reflecting the selected and rated travel properties to the user computer 125.

In one embodiment, the match tool 310 might construct the travel property list by starting with no matched properties, adding travel properties that have a positive average attribute rating to the list of matched properties, and then sorting the added travel properties by the average rating assigned.

In one embodiment, the match tool 310 might allow a user to sort the travel property list by values other than the average attribute rating. These values might include shortest travel time, price, rating, or the average attribute rating of only one prospective traveler.

### Travel Booking Method

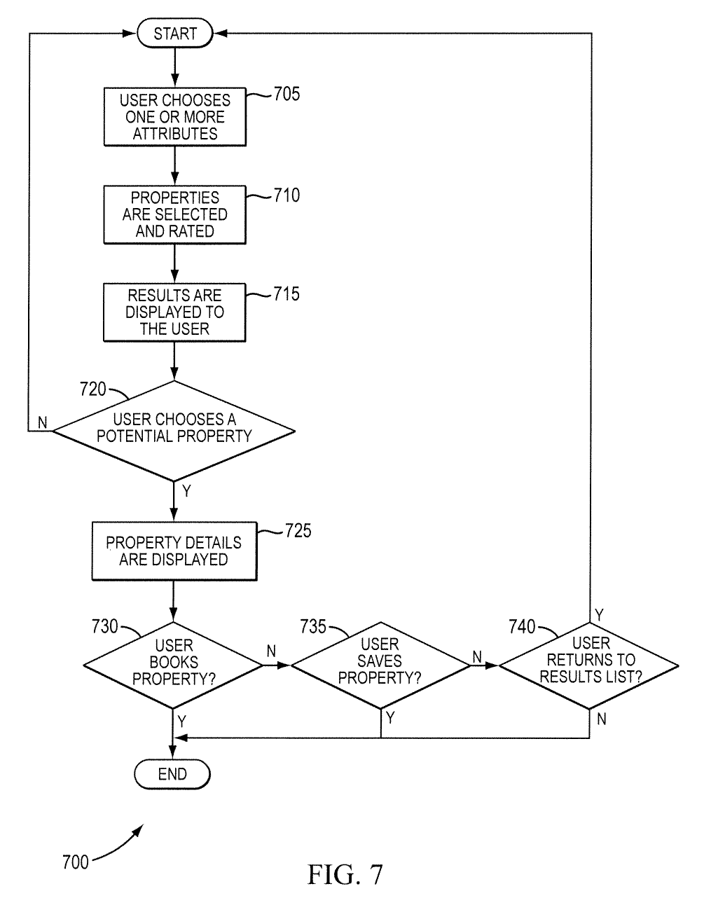

FIG. 7 shows a flowchart of a travel booking method 700, in accordance with an embodiment of the present invention. The travel booking method 700 begins in step 705 with the user making one or more travel planning choices using the planning tool 305. In step 710, the match tool selects and rates travel properties according to the method shown in FIG. 6. In step 715, the display tool 325 transmits a match results display reflecting the selected and rated travel properties to the user computer 125.

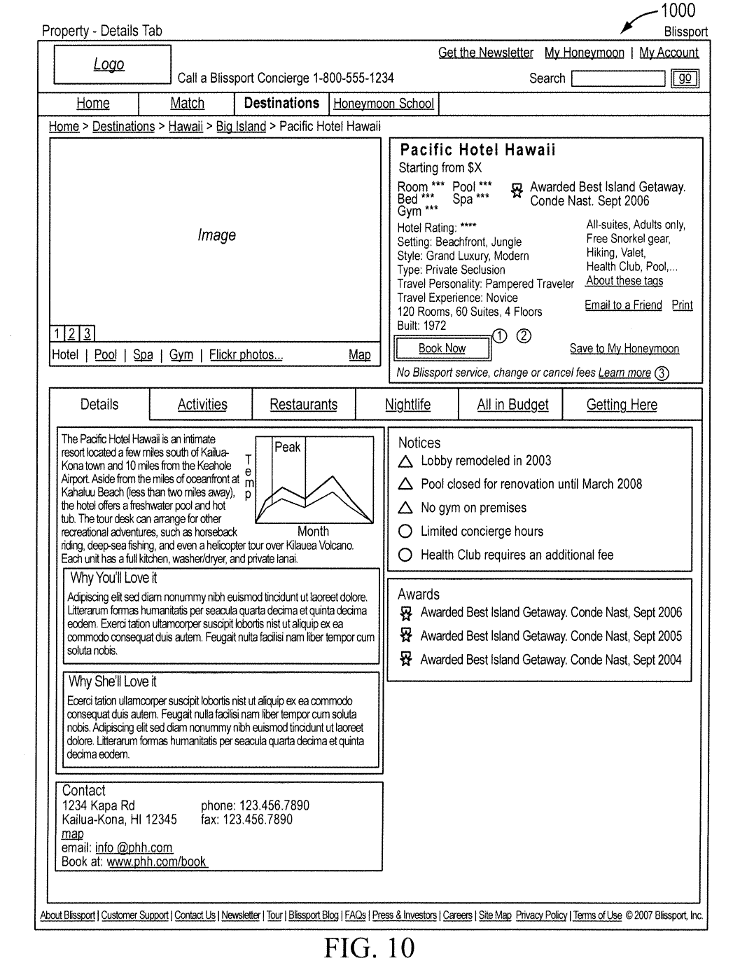

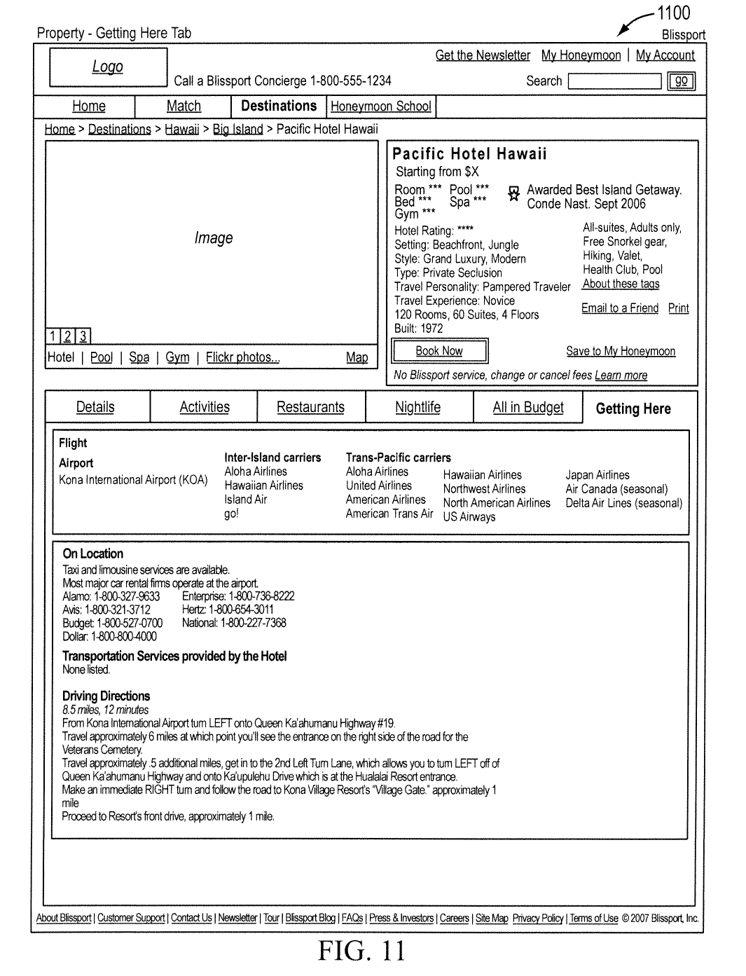

In step 720, the user chooses a travel property of interest from the match results display. In step 725, the display tool transmits a display reflecting property details to the user computer 125. FIG. 10 is a wire frame mockup of a property details display, in accordance with an embodiment of the present invention. The user may chose from among different displays of property details, including a display detailing tourist activities located on or near the travel property, a display detailing restaurants located on or near the travel property, a display detailing nightlife activities located on or near the travel property, and a “getting here” display detailing how to get to the travel property. FIG. 11 is a wire frame mockup of a “getting here” display detailing how to get to a travel property, in accordance with an embodiment of the present invention.

In step 730, the user decides whether to book a room at the chosen travel property. If yes, then the booking tool 330 books a room at the travel property for the user and the method 700 ends. If not, then the method 700 proceeds to step 735. In step 735, the user decides whether to save the chosen travel property in a user database 420 for future reference. If yes, then the booking tool 330 saves the chosen travel property in the user database 420 and the method 700 ends. If not, then the method 700 proceeds to step 740. In step 740, the user decides whether to return to the match results display. If yes, then the method 700 returns to step 715. If not, then the method 700 ends.

Booking is not just for properties, the above paragraph needs to be repeated for flights, activities, ground transportation, and rental cars. For air and car, the user also has the choice to go to a third party solution for booking as described in the Interactive Itinerary Planner section.

### Interactive Itinerary Planner

With reference to FIG. 3, the interactive itinerary planning tool 335 includes hardware, software, and/or firmware operative to add, change, and delete travel items from a travel itinerary. Travel items may include ground transportation to an airport, a flight, rental car pickup, ground transportation to a hotel, hotel check in, tourist activities, meals, nightlife activities, hotel check out, and rental car drop-off. In adding travel items to a travel itinerary, the interactive itinerary planning tool 335 may consult the property database 410, a flight database 425, an activities database 430, a nightlife database 435, a restaurants database 440, a rental car database 445, a ground transportation database 450, and a “make it special” database 455. The interactive itinerary planning tool 335 may also consult hotel websites 120a, airline websites 120b, tourist activity websites 120c, nightlife websites 120d, restaurant websites 120e, rental car websites 120f, ground transportation websites 120g, and other websites 120h. In one embodiment, the interactive planning tool 335 is configured to search these databases and websites for travel opportunities based upon travel specials, marketing, or special events. In one embodiment, the interactive itinerary planning tool 335 enables the traveler to enter activities, other travel arrangements, reservation numbers, etc. into the system manually, so that the entire travel itinerary is stored in one place and the experience planning tool 340 can track travel planning progress, as described below.

In one embodiment, the interactive itinerary planning tool 335 is configured to suggest optimized itinerary schedules to a user based upon travel times and other constraints. For example, if a prospective traveler to the San Francisco Bay Area wants to see Union Square, Chinatown and Fisherman's Warf in San Francisco, and Lake Merritt, the Oakland Zoo and Jack London Square in Oakland, then the interactive itinerary planning tool 335 might suggest that the prospective traveler optimize his or her schedule by planning the San Francisco-based activities for one day and the Oakland-based activities for another.

In one embodiment, the interactive itinerary planning tool 335 is configured to transmit an itinerary planning display reflecting travel items placed on a travel itinerary to the user computer 125. The display may include text, images, and/or video associated with the travel items. The interactive itinerary planning tool 335 may also be configured to save a partial or complete travel itinerary to the user database 420, and to print a partial or complete travel itinerary reflecting booking numbers, dates, and times on a printer attached as an output device 130 to the user computer 125.

In one embodiment, the interactive itinerary planning tool 335 is configured to allow third parties to search for and see a user's itinerary, and to copy all or portions of the user's itinerary for their use. The user may have the option of specifying that he or she wants his or her itinerary to be kept private or to be made public only after a certain event has happened (e.g., the user has returned from the travel experience). The user may have the, option of sending his or her itinerary to a friend by marking the itinerary or a portion of the itinerary for publishing to a specific user or all users or other user via an e-mail from the travel planning system 300 or by cutting and pasting a system-generated link into an e-mail created using third-party software (e.g., Microsoft Outlook), among other ways. The interactive itinerary planning tool 335 may automatically make others' itineraries public after a predetermined time, after a predetermined event, upon request, etc.

When a second user copies all or portions of the user's itinerary for the second user's use, the interactive itinerary planning tool 335 can either create a new itinerary for the second user or add the copied portions of the user's itinerary to an existing itinerary for the second user. In either case, the copied portions of the user's itinerary become an active itinerary separate and distinct from the user's itinerary. The second user may edit and book items in the copied portions using the interactive itinerary planning tool 335 (e.g., the second user can modify aspects of the itinerary such as rooms, activities, or flights and can book these aspects through the travel planning system 300).

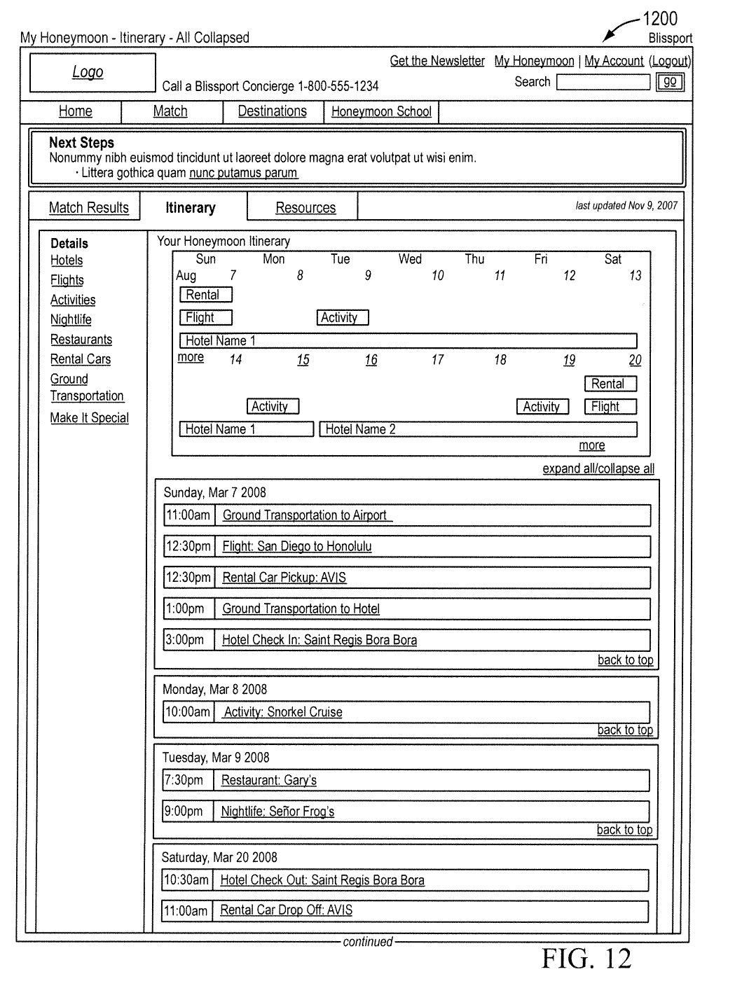

FIG. 12 is a wire frame mockup of an itinerary planning display 1200, in accordance with an embodiment of the present invention. The itinerary planning display 1200 features an itinerary calendar 1205 showing the days on which various travel items are scheduled to occur. The itinerary planning display 1200 also features daily itinerary lists 1210 showing the times at which various travel items are scheduled to occur. The display is configured so that selecting a travel item with an input device 135 triggers the display of details pertaining to the selected travel item. Travel items that have been chosen for the travel itinerary but that have not yet been scheduled for specific dates and times may be separately listed on the itinerary planning display.

In one embodiment, the interactive itinerary planning tool 335 is configured to transmit a hotel details display, a flight details display, an activity details display, a nightlife details display, a restaurant details display, a rental car details display, a ground transportation details display, and a “make it special” details display to the user computer 125 upon request from the user.

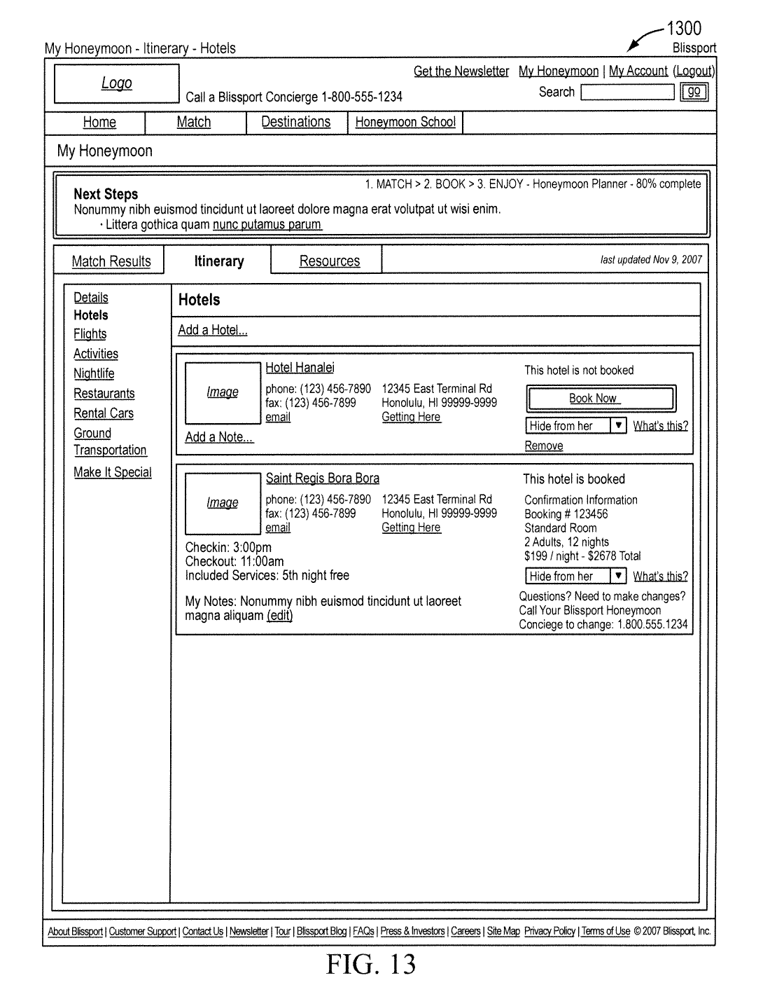

FIG. 13 is a wire frame mockup of a hotel details display 1300, in accordance with an embodiment of the present invention. The hotel details display 1300 shows information pertaining to hotels and other travel properties that a user has added to a travel itinerary. The interactive itinerary planning tool 335 may retrieve this information from the property database 410 and/or from the hotel websites 120a. The hotel details display may include text, images, and/or video associated with the travel properties. The user may add additional travel properties by selecting “Add a hotel . . . ” using an input device 135. Additionally, the user may add a personal note to the hotel details display 1300 by selecting “Add a note . . . ” using an input device 135. The hotel details display 1300 is configured so that selecting the name of a travel property using an input device 135 triggers the display of details pertaining to the selected travel property. Similarly, selecting “Getting Here” using an input device 135 triggers the display of details pertaining to how to get to the selected travel property. Selecting “Remove” using an input device 135 removes the travel property from the travel itinerary.

The hotel details display 1300 shows whether or not the user has booked a room at the travel properties that have been added to the travel itinerary. The user may book a room at an unbooked travel property by selecting “Book Now” using an input device 135. When the travel property has been booked, the hotel details display 1300 reflects this fact and shows travel property confirmation information, including a booking number, type of room (e.g., standard, suite, etc.), number of guests, length of stay, nightly room cost, total hotel cost, check-in time, check-out time, and any included services (e.g., fifth night free). To complete the booking, the interactive itinerary planning tool 335 may need to communicate with one or more of the websites 120. If the user booked the hotel, but not through the travel planning system 300, then the user may enter booking information (including title, description, date, time, notes, etc.) manually.

In one embodiment, the interactive itinerary planning tool 335 is configured so that different users can have different user accounts, and one user can hide selected travel items from other users. For example, a groom might want to hide information pertaining to a particular hotel from his bride. To do this, the groom may select “Hide from her” on the hotel details display 1300 using an input device 135. Selecting “Hide from her” will hide information pertaining to the hidden hotel from other users. In one embodiment, the user may chose whether the hotel will simply be hidden from the other users, or whether the other users will see an affirmative notation that a “surprise” hotel has been booked. After “Hide from her” has been selected, the hotel details display is updated to replace the “Hide from her” option with a “Show her” option that, if selected, will reveal the information pertaining to the hidden hotel The “Hide from her” and “Show her” options may be similarly implemented on the flight details display, the activity details display, the nightlife details display, the restaurant details display, the rental car details display, the ground transportation details display, and the “make it special” details display.

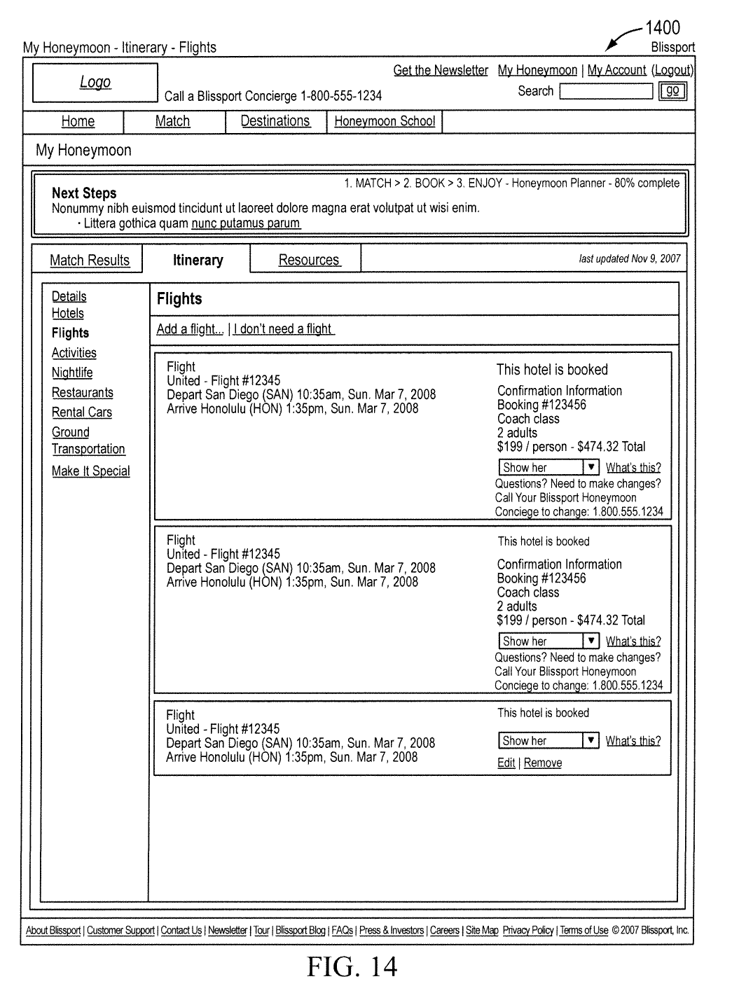

FIG. 14 is a wire frame mockup of a flight details display 1400, in accordance with an embodiment of the present invention. The flight details display 1400 shows information pertaining to flights that a user has added to a travel itinerary. The interactive itinerary planning tool 335 may retrieve this information from the flight database 425 and/or from the airline websites 120b. The flight details display may include text, images, and/or video associated with the flights. The user may add additional flights by selecting “Add a flight . . . ” using an input device 135. Alternatively, the user may indicate to the interactive itinerary planning tool 335 that the user does not need a flight by selecting “I don't need a flight” using an input device 135. Selecting “Remove” using an input device 135 removes a flight from the travel itinerary. Additionally, the user may add a personal note to the flight details display 1400 by selecting “Add a note . . . ” (not shown) using an input device 135.

The flight details display 1400 shows whether or not the user has booked a seat on the flights that have been added to the travel itinerary. The user may book a seat at an unbooked travel property by selecting “Book Now” (not shown) using an input device 135. When the flight is booked, the flight details display 1400 reflects this fact and shows flight confirmation information, including a booking number, cabin choice (e.g., first class, coach, etc.), number of passengers, ticket price, and total flight cost. To complete the booking, the interactive itinerary planning tool 335 may need to communicate with one or more of the websites 120. If the user booked the flight, but not through the travel planning system 300, then the user may enter the booking information manually.

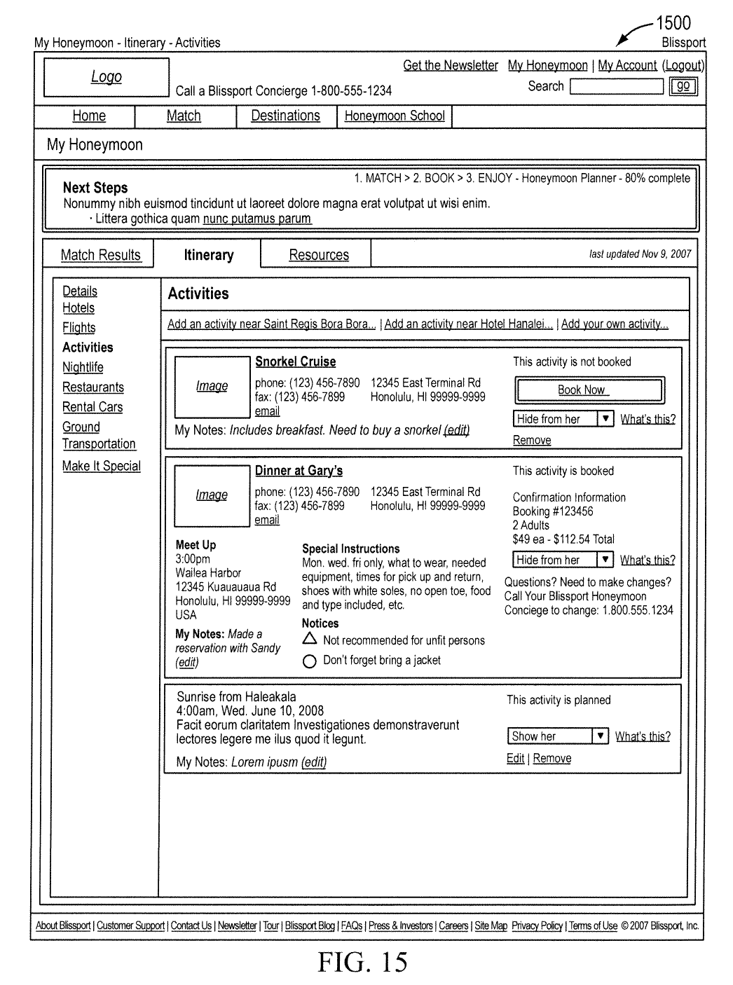

FIG. 15 is a wire frame mockup of an activity details display 1500, in accordance with an embodiment of the present invention. The activity details display 1500 shows information pertaining to activities that a user has added to a travel itinerary. The interactive itinerary planning tool 335 may retrieve this information from the user database 420, from the activities database 430, and/or from the tourist activity websites 120c. The activity details display may include text, images, and/or video associated with the activities.

The interactive itinerary planning tool 335 is configured to search the activities database 430 and/or tourist activity websites 120c for activities that are near travel properties that the user has added to an itinerary, and to allow the user to add these activities to the itinerary. For example, as shown in FIG. 15, a user may add an activity near the Saint Regis Bora Bora resort by selecting “Add an activity near Saint Regis Bora Bora . . . ” using an input device 135. The user may add additional activities by selecting “Add your own activity . . . ” using an input device 135. Additionally, the user may add a personal note to the activity details display 1500 by selecting “Add a note . . . ” (not shown) using an input device 135. The activity details display 1500 is configured so that selecting the name of an activity using an input device 135 triggers the display of details pertaining to the selected activity. Selecting “Remove” using an input device 135 removes the activity from the travel itinerary.

The activity details display 1500 shows whether or not the user has booked the activities that have been added to the travel itinerary. The user may book an unbooked activity by selecting “Book Now” using an input device 135 for those activity that are capable of being booked through the travel planning network system 100. When the activity has been booked, the activity details display 1500 reflects this fact and shows activity confirmation information, including a booking number, number of participants, cost per participant, total activity cost, meeting time, meeting place, and any special instructions or notices (e.g., no open toe shoes, not recommended for unfit persons, bring a jacket, etc.). To complete the booking, the interactive itinerary planning tool 335 may need to communicate with one or more of the websites 120. If the user booked the activity, but not through the travel planning system 300, then the user may enter the booking information manually.

The nightlife details display and restaurant details display may function similarly to the activity details display 1500.

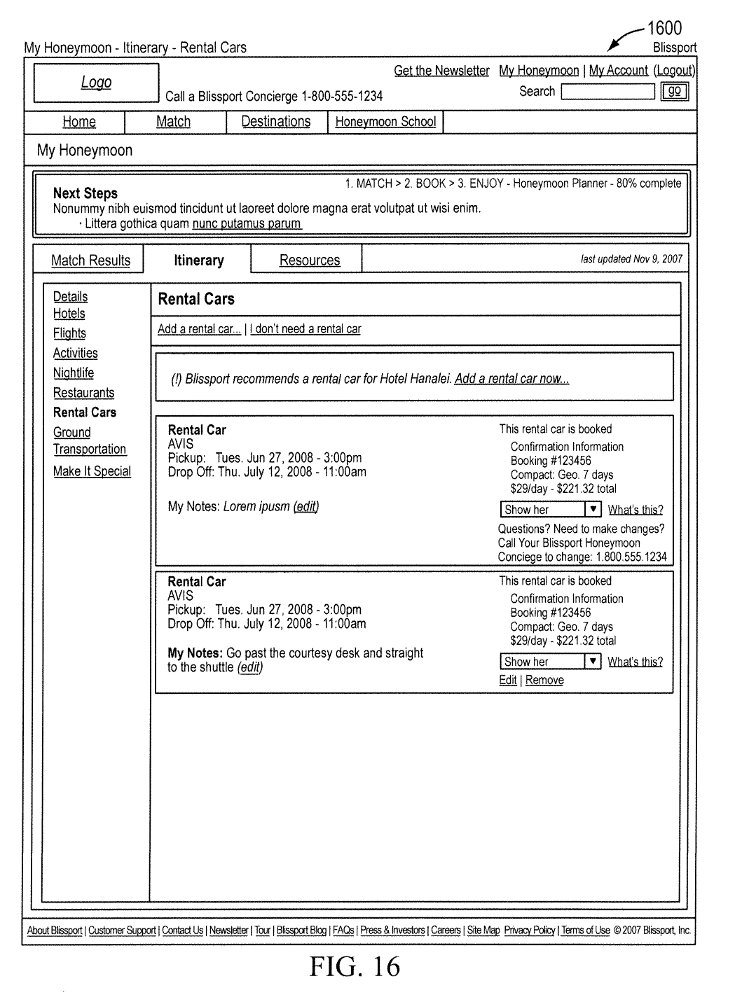

FIG. 16 is a wire frame mockup of a rental car details display 1600, in accordance with an embodiment of the present invention. The rental car details display 1600 shows information pertaining to rental cars that a user has added to a travel itinerary. The interactive itinerary planning tool 335 may retrieve this information from the rental car database 445 and/or from the rental car websites 120f. The rental car details display may include text, images, and/or video associated with the rental cars. The user may add additional rental cars by selecting “Add a rental car . . . ” using an input device 135. Alternatively, the user may indicate to the interactive itinerary planning tool 335 that the user does not need a rental car by selecting “I don't need a rental car” using an input device 135. The interactive itinerary planning tool 335 is configured to alert the user if a rental car is recommended for any of the travel properties that have been added to the travel itinerary. Selecting “Remove” using an input device 135 removes a rental car from the travel itinerary. The user may add a personal note to the rental car details display 1600, by selecting “Add a note . . . ” (not shown) using an input device 135.

The rental car details display 1600 shows whether or not the user has booked the rental cars that have been added to the travel itinerary. The user may book an unbooked rental car by selecting “Book Now” (not shown) using an input device 135. When the rental car is booked, the rental car details display 1600 reflects this fact and shows rental car confirmation information, including a booking number, the cost per day, the total rental car cost the pickup date and time, and the drop-off date and time. To complete the booking, the interactive itinerary planning tool 335 may need to communicate with one or more of the websites 120. If the user booked the rental car, but not through the travel planning system 300, then the user may enter the booking information manually. The travel planning system 300 may access a third-party website to facilitate rental car booking, such as Kayak.com.

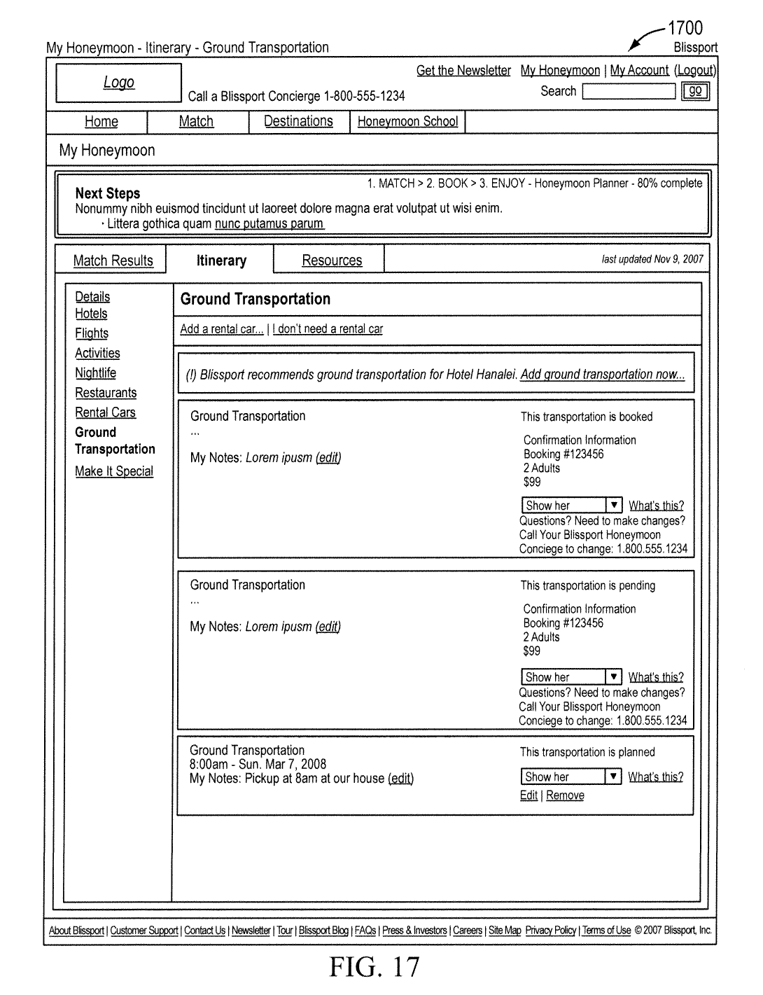

FIG. 17 is a wire frame mockup of a ground transportation details display 1700, in accordance with an embodiment of the present invention. The ground transportation details display 1700 shows information pertaining to ground transportation that a user has added to a travel itinerary. The interactive itinerary planning tool 335 may retrieve this information from the ground transportation database 450 and/or from the ground transportation websites 120g. The ground transportation details display may include text, images, and/or video associated with the ground transportation. The user may add additional ground transportation by selecting “Add ground transportation . . . ” using an input device 135. Alternatively the user may indicate to the interactive itinerary planning tool 335 that the user does not need ground transportation by selecting “I don't need ground transportation” using an input device 135. The interactive itinerary planning tool 335 is configured to alert the user if ground transportation is recommended for any of the travel properties that have been added to the travel itinerary. Selecting “Remove” using an input device 135 removes an item of ground transportation from the travel itinerary. The user may add a personal note to the ground transportation details display 1700 by selecting “Add a note . . . ” (not shown) using an input device 135.

The ground transportation details display 1700 shows whether or not the user has booked the ground transportation items that have been added to the travel itinerary. The user may book an unbooked ground transportation item by selecting “Book Now” (not shown) using an input device 135. When a ground transportation item is booked the ground transportation details display 1700 reflects this fact and shows ground transportation confirmation information, including a booking number, the number of riders, and the cost. To complete the booking, the interactive itinerary planning tool 335 may need to communicate with one or more of the websites 120. If the user booked the ground transportation, but not through the travel planning system 300, then the user may enter the booking information manually.

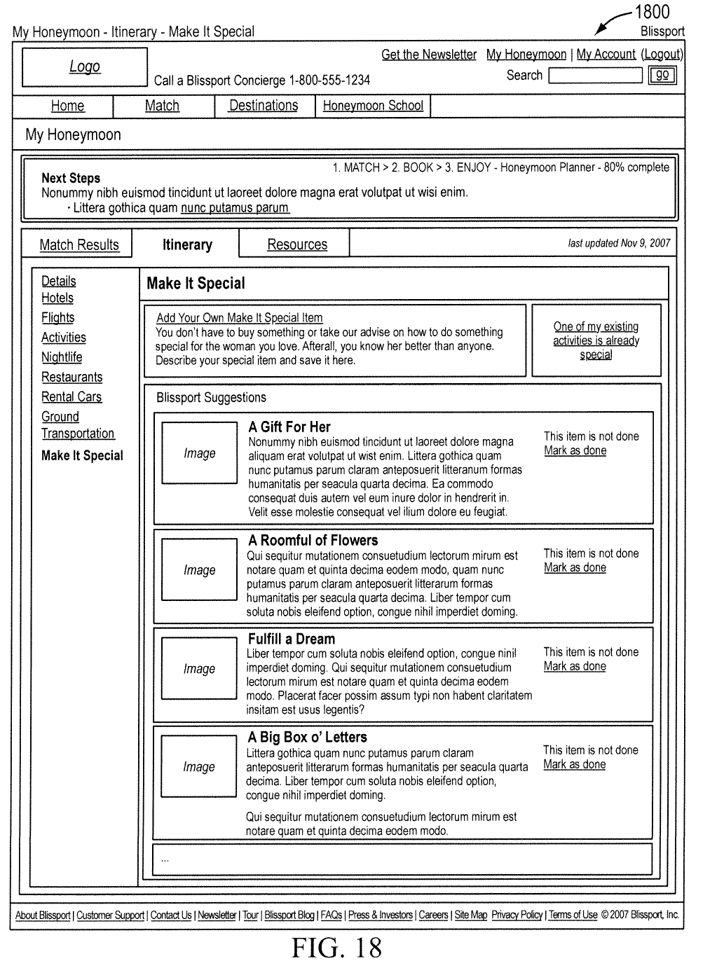

FIG. 18 is a wire frame mockup of “make it special” details display 1800, in accordance with an embodiment of the present invention. The “make it special” details display 1800 allows the user to add special items to a travel itinerary or to an item in a travel itinerary. For example, if a groom planned a dinner for his bride, he could make the dinner “special” by giving his bride a gift of earrings at the dinner. Additionally, the groom could add a “special” itinerary item (e.g., a morning at the spa). The “make it special” details display 1800 shows information pertaining to special items that a user has added to a travel itinerary. The interactive itinerary planning tool 335 may retrieve this information from the user database 420, the “make it special” database 455, and/or from websites 120. The “make it special” details display may include text, images, and/or video associated with the special items. The user may add a personal note to the “make it special” details display 1800, by selecting “Add a note . . . ” (not shown) using an input device 135.

The interactive itinerary planning tool 335 is configured to search the “make it special” database 455 and/or websites 120 for special terms that might be appropriate to include, e.g., additional activities and/or specific items to include with travel activities that the user has added to an itinerary, and to allow the user to add these special items to the itinerary. For example, the interactive itinerary planning tool 335 may recommend getting massages together, a gift during a dinner, pre-ordering champagne, and/or the like. The user may add additional special items by selecting “Add Your Own Make It Special Items” using an input device 135. Additionally, the user may designate existing items on an itinerary as special by selecting “One of my existing activities is already special” using an input device 135.

### Experience Planning Tool

With reference to FIG. 3, the experience planning tool 340 includes hardware, software, and/or firmware operative to track the progress of the itinerary planning toward completion and to transmit this progress information to the user computer 125. For example, the experience planning tool 340 might determine that a travel itinerary is 25 percent complete when the user has only booked hotels, whereas the tool might determine that a travel itinerary is 80 percent complete when the user has booked hotels, flights, rental cars, and activities, but no “make it special” items. In one embodiment, the user can specify for the experience planning, tool 340 what should and should not be tracked. For example, the user might specify that rental cars should not be part of the tracking if the user does not intend to rent a car during the travel experience.

In one embodiment, the experience planning tool will account for use of the match tool 310 to determine that a travel itinerary is 10% complete or 15% if the planning tool 305 has been sent to a second user to “Get her Input.”

In one embodiment, the experience planning tool 340 will account for manually entered activities, travel arrangements, etc.

In one embodiment, the experience planning tool 340 is configured to inform the user, upon request, of the minimum necessary itinerary elements for a great travel experience. For example, the experience planning tool 340 might inform the user that a great travel experience requires, among other things, three “make it special” items, and include these three “make it special” items in its tracking.

In one embodiment, the experience planning tool 340 can provide planning reminders to the user at various times prior to a scheduled travel experience. For example, at three months before the start of the travel experience, the experience planning tool 340 can remind the user that it is time to book flights. At two months before the start of the travel experience, the experience planning tool 340 can remind the user that it is time to book hotels, etc.

### Advertising and Promotion Tool

With reference to FIG. 3, the advertising and promotion to 345 includes hardware, software, and/or firmware operative to add advertisements and promotional messages to the itinerary planning display, hotel details display, flight details display, activity details display, nightlife details display, restaurant details display, rental car details display, ground transportation details display, and “make it special” details display. In one embodiment, the advertising and promotion tool 345 is configured to target the advertisements and promotional messages based upon the travel items that a user has added to an itinerary or is reviewing, and to allow the user to read relevant content or purchase the advertised goods or services through the travel planning system 300 or a third party system. For example, if the user adds a hotel located in a sunny locale to an itinerary, then the advertising and promotion tool might place an advertisement on the hotel details display for a sunglasses company and allow the user to purchase sunglasses through that advertisement. The advertising and promotion tool 345 may cooperate with the interactive itinerary planning tool 335, e.g., when offering other ideas to make a part of the travel special.

### Traveler Profile Tool

With reference to FIG. 3, the traveler profile tool 350 includes hardware, software, and/or firmware operative to obtain a traveler profile representing a user's personality type and travel experience. The traveler profile tool 350 can use data about the user's personality type and travel experience to determine the user's potential satisfaction with various travel properties. A user's traveler profile can be obtained through surveys, questionnaires or reviews, and can be calculated iteratively over time. Based on user input, the traveler profile tool 350 can calculate a rating for each user for each of the following or other personality types: “Chart the Course,” “In Charge,” “Behind the Scenes,” and “Get Things Going.”

The traveler profile tool 350 can then weight the attributes contained in the property database 410 according to each personality type. Thus, a user with a high score in one personality type can be steered toward travel properties that might best suit that personality type. For instance, the traveler profile tool 350 could assign the following multipliers to the “Good Food” attribute:

“Chart the Course”=1.2

“In Charge”=0.8

“Behind the Scenes”=1.7

“Get Things Going”=0.4

In the above example, the match results for a user having a high “Behind the Scenes” score would be heavily weighted by the “Good Food” attribute, while the match results for someone having a high “Get Things Going” score would not.

In addition, post-trip satisfaction surveys, ratings, reviews, or other feedback mechanisms can be applied to the attribute weightings to more accurately weight the personality types. Post-trip satisfaction surveys and other feedback mechanisms can also be used to suggest entire itineraries (hotels, activities, restaurants, etc.) to other users having similar personality types.

### Travel Item Selection Method

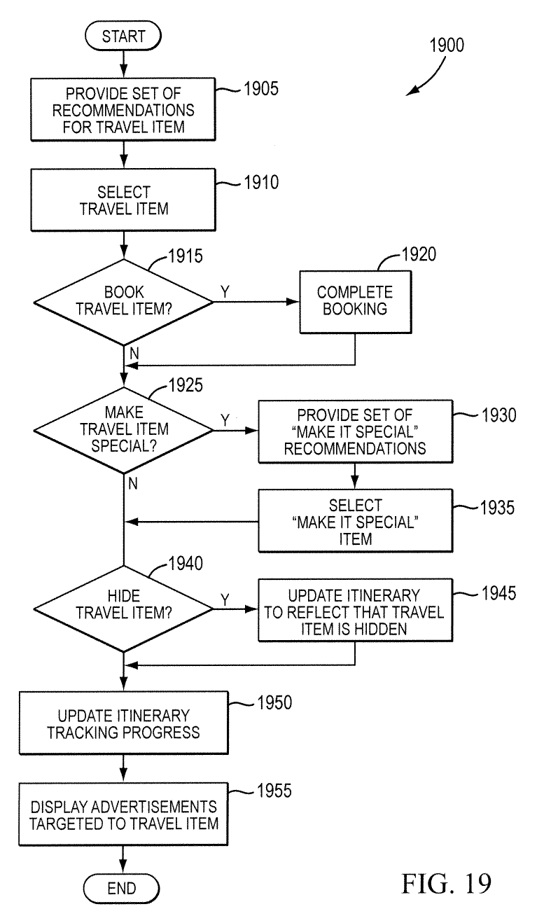

FIG. 19 shows a flowchart of a travel item selection method 1900 for a travel itinerary, in accordance with an embodiment of the present invention. The travel item selection method 1900 begins in step 1905 with the interactive itinerary planning tool 335 providing a set of recommendations for the travel item to the user computer 125. In step 1910, the user selects a travel item. In step 1915, the interactive itinerary planning tool 335 asks the user whether the user wants to book the travel item. If yes, then the method 1900 proceeds to step 1920, where the booking is completed.

In step 1925, the interactive itinerary planning tool 335 asks the user whether the user wants to make the travel item “special.” If yes, then the method 1900 proceeds to step 1930. In step 1930, the interactive itinerary planning tool 335 provides a set of “make if special” recommendations to the user. In step 1935, the user selects a “make it special” item.

In step 1940, the interactive itinerary planning tool 335 asks the user whether the user wants to hide the travel item. If yes, then the method 1900 proceeds to step 1945, where the interactive itinerary planning tool updates the itinerary to reflect that the travel item is hidden.

In step 1950, the experience planning tool 340 updates the experience planning progress. In step 1955, the advertising and promotion tool 345 displays one or more advertisements targeted to the selected travel item. The method 1900 then ends.

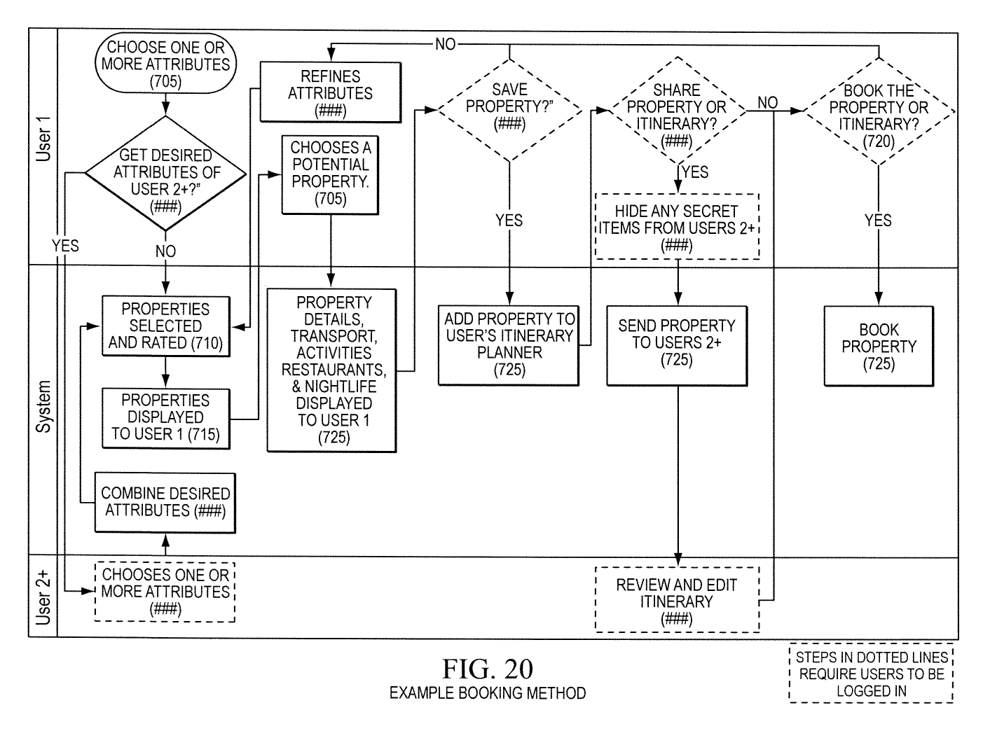

FIG. 20 is a flowchart of travel booking method, in accordance with an embodiment of the present invention.

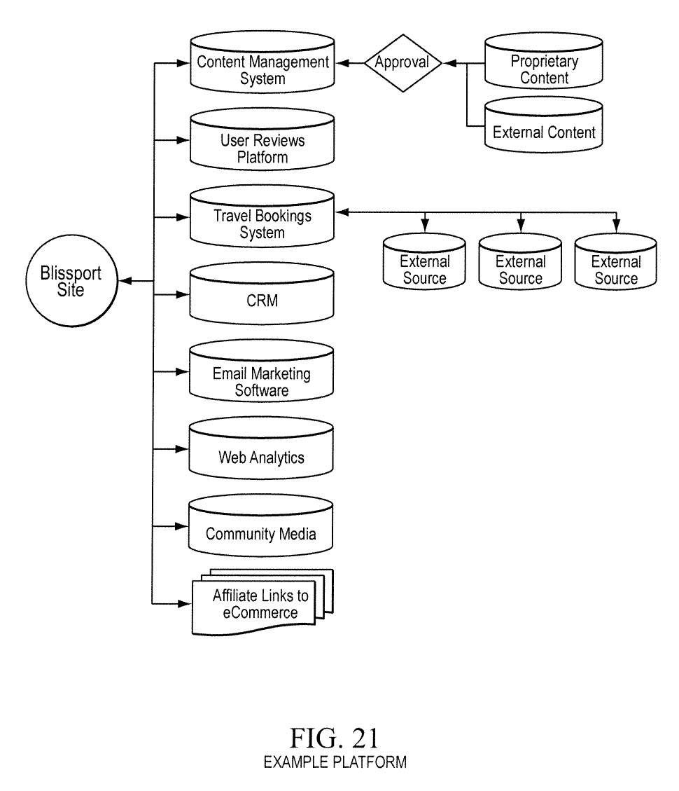

FIG. 21 is a block diagram of an example architecture of the travel planning server, in accordance with an embodiment of the present invention.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A travel planning system comprising:
a travel planning tool operative to provide a first set of at least one first travel information request to a first user and to receive a first set of at least one first travel information response from the first user;
a match tool coupled to the travel planning tool and operative to rate travel properties based upon the first set of at least one first travel information response of the first user;
a booking tool coupled to the match tool and operative to enable the first user to book a specific travel property based on the travel property ratings; and
an experience planning tool coupled to the interactive itinerary planning tool and the booking tool and operative to track travel planning progress.

2. The travel planning system of claim 1, wherein the travel planning system is dedicated to honeymoon traveling.

3. The travel planning system of claim 1, wherein the travel planning tool enables the first user to identify desired travel attributes including travel type and activity preferences.

4. The travel planning system of claim 1, wherein the travel planning tool enables the first user to select required attributes and desired attributes.

5. The travel planning system of claim 4, wherein the required and preferred attributes include hotel information, travel type, activities information, travel personality, travel experience, nightlife information, and food/restaurant information.

6. The travel planning system of claim 4, wherein the match tool rates and ranks properties by examining required attributes and desired attributes.

7. The travel planning system of claim 1, wherein the experience planning tool tracks travel and activity needs of the first user and booking of the travel and activity needs.

8. The travel planning system of claim 7, wherein the itinerary planning tool makes recommendations to achieve a good travel experience.

9. The travel planning system of claim 1, wherein the travel planning tool enables a second user to view at least a portion of the first travel information responses.

10. The travel planning system of claim 9, wherein the travel planning tool enables the first user to select which first travel information responses to show the second user.

11. The travel planning system of claim 10, wherein the travel planning tool is operative to provide a second set of at least one second travel information request to the second user and to receive a second set of at least one second travel information response from the second user.

12. The travel planning system of claim 10, wherein, the travel planning tool is operative to recommend an activity, product, or action to improve a travel or activity experience or a gift, item, or action to improve an activity experience.

13. The travel planning system of claim 11, wherein the match tool is operative to rate and rank travel properties based upon the first set of at least one first travel information response and the second set of at least one second travel information response.

14. The travel planning system of claim 1, wherein the first set of first travel information response do not include a geographic location.

15. The travel planning system of claim 1, further comprising an advertising and promotion tool operative to advertise items of possible interest based on the travel information responses.

16. A travel planning method comprising:
providing a first set of at least one first travel information request to a first user;
receiving a first set of at least one first travel information response from the first user;
rating and ranking travel properties based upon the first set of at least one first travel information response of the first user;
enabling the first user to book a specific travel property and related travel items based on the travel property ratings; and
tracking travel planning progress.

17. The travel planning method of claim 16, wherein the method is dedicated to honeymoon traveling.

18. The travel planning method of claim 16, further comprising enabling the first user to identify desired travel attributes including travel type and activity preferences.

19. The travel planning method of claim 16, further comprising enabling the first user to select required attributes and desired attributes.

20. The travel planning method of claim 19, wherein the required and preferred attributes include hotel information, travel type, activities information, travel personality, travel experience, nightlife information, and food/restaurant information.

21. The travel planning method of claim 19, wherein the rating properties includes examining required attributes and desired attributes.

22. The travel planning method of claim 16, further comprising travel and activity needs of the first user and booking of the travel and activity heeds.

23. The travel planning method of claim 22, further comprising making recommendations to achieve a good travel experience.

24. The travel planning method of claim 16, further comprising enabling a second user to view at least a portion of the first travel information responses.

25. The travel planning method of claim 24, further comprising enabling the first user to select which first travel information responses to show the second user.

26. The travel planning method of claim 24, further comprising providing a second set of at least one second travel information request to the second user and receiving a second set of at least one second travel information response from the second user.

27. The travel planning method of claim 25, further comprising recommending an activity, product, or action to improve a travel experience or a gift, item, or action to improve an activity experience.

28. The travel planning method of claim 26, further comprising rating travel properties based upon the first set of at least one first travel information response and the second set of at least one second travel information response.

29. The travel planning method of claim 16, wherein the first set of first travel information response do not include a geographic location.

30. The travel planning method of claim 16, further comprising advertising items of possible interest based on the travel information responses.

31. A travel planning system comprising:
means for providing a first set of at least one first travel information request to a first user;
means for receiving a first set of at least one first travel information response from the first user;
means for rating travel properties based upon the first set of at least one first travel information response of the first user;
means for enabling the first user to book a specific travel property based on the travel property ratings; and
means for tracking travel planning progress.
